(19) United States
(12) Patent Application Publication
(10) Pub. No.: US 2016/0373744 A1
(43) Pub. Date: Dec. 22, 2016

(54) IMAGE PROCESSING APPARATUS AND IMAGE PROCESSING METHOD

(71) Applicant: SONY CORPORATION, Tokyo (JP)

(72) Inventors: Shuo LU, Tokyo (JP); Junichi TANAKA, Kanagawa (JP); Hironari SAKURAI, Kanagawa (JP); Takefumi NAGUMO, Kanagawa (JP)

(73) Assignee: SONY CORPORATION, Tokyo (JP)

(21) Appl. No.: 15/120,950

(22) PCT Filed: Apr. 10, 2015
(86) PCT No.: PCT/JP2015/061259

§ 371 Date: Aug. 23, 2016

(30) Foreign Application Priority Data
Apr. 23, 2014 (JP) 2014-089240

(51) Int. Cl. H04N 19/119; H04N 19/105; H04N 19/176; H04N 19/122; H04N 19/157

(52) U.S. Cl. CPC H04N 19/119; H04N 19/122; H04N 19/157; H04N 19/176; H04N 19/105

(57) ABSTRACT

There is provided an image processing apparatus to relax performance requirements of an encoder to be less than in a technique of searching all block sizes comprehensively, including: a setting section configured to set a size of at least one of a coding unit formed by recursively dividing an image to be encoded and a prediction unit to be set in the coding unit according to a search range of the size of the at least one of the coding unit and the prediction unit, one or more smallest candidate sizes among all candidate sizes being excluded from the search range; and an encoding section configured to encode the image according to the size of the coding unit or the prediction unit set by the setting section.

### TECHNICAL FIELD

The present disclosure relates to an image processing apparatus and an image processing method.

### BACKGROUND ART

The standardization of an image coding scheme called HEVC (High Efficiency Video Coding) by JCTVC (Joint Collaboration Team-Video Coding), which is a joint standardization organization of ITU-T and ISO/IEC, is currently under way for the purpose of improving coding efficiency more than H. 264/AVC (see, for example, Non-Patent Literature 1).

In known image coding schemes such as MPEG2 or H.264/AVC, an encoding process is performed in processing units called macroblocks. The macroblocks are blocks having a uniform size of 16×16 pixels. On the other hand, in HEVC, the encoding process is performed in processing units called coding units (CUs). The CUs are blocks having variable sizes formed by recursively dividing a largest coding unit (LCU). A largest size of selectable CUs is 64×64 pixels. A smallest size of selectable CUs is 8×8 pixels. As a result of employing the CUs having variable sizes, in HEVC, it is possible to adaptively adjust the image quality and the coding efficiency according to content of an image. A prediction process for predictive encoding is performed in processing units called prediction units (PUs). The PUs are formed by dividing the CU in one of several division patterns. Further, an orthogonal transform process is performed in processing units called transform units (TUs). The TUs are formed by dividing the CU or the PU up to a certain depth.

### CITATION LIST

### Non-Patent Literature

Non-Patent Literature 1: Benjamin Bross, el. al, “High Efficiency Video Coding (HEVC) text specification draft 10 (for FDIS & Consent)” (JCTVC-L1003 v4, Jan. 14 to 23, 2013)

### PATENT LITERATURE

Patent Literature 1: JP 2008-078969A

### SUMMARY OF INVENTION

### Technical Problem

A block division that is performed to set blocks such as the CUs, the PUs, or the TUs in an image is typically decided based on a comparison of the costs influencing the coding efficiency. However, as the number of block size patterns whose costs are compared increases, higher performance is required in an encoder, and a cost of implementing the encoder increases considerably.

Thus, it is desirable to provide a technique capable of relaxing performance requirements of an encoder to be less than in a technique of searching all block sizes comprehensively.

### Solution to Problem

According to the present disclosure, there is provided an image processing apparatus including: a setting section configured to set a size of at least one of a coding unit formed by recursively dividing an image to be encoded and a prediction unit to be set in the coding unit according to a search range of the size of the at least one of the coding unit and the prediction unit, one or more smallest candidate sizes among all candidate sizes being excluded from the search range; and an encoding section configured to encode the image according to the size of the coding unit or the prediction unit set by the setting section.

According to the present disclosure, there is provided an image processing method including: setting a size of at least one of a coding unit formed by recursively dividing an image to be encoded and a prediction unit to be set in the coding unit according to a search range of the size of the at least one of the coding unit and the prediction unit, one or more smallest candidate sizes among all candidate sizes being excluded from the search range; and encoding the image according to the set size of the coding unit or the prediction unit.

### Advantageous Effects of Invention

According to the technology according to the present disclosure, it is possible to relax performance requirements of an encoder and reduce the implementation cost of an encoder.

The above effect is not necessarily limited, and effects described in this specification or other effects that can be understood from this specification may be obtained in addition to the above effect or instead of the above effect.

### BRIEF DESCRIPTION OF DRAWINGS

FIG. 1 is an explanatory view for describing an overview of recursive block division on a CU in HEVC.

FIG. 2 is an explanatory view for describing a setting of a PU in the CU illustrated in FIG. 1.

FIG. 3 is an explanatory view for describing a setting of a TU in the CU illustrated in FIG. 1.

FIG. 4 is an explanatory view for describing a scan order of a CU/PU.

FIG. 5 is an explanatory view for describing reference to a neighboring PU in an inter prediction process.

FIG. 6 is an explanatory view for describing reference to a neighboring PU in an intra prediction process.

FIG. 7 is a graph illustrating an example of a relation between a CU size and memory capacity requirements.

FIG. 8 is a graph illustrating an example of a relation between a TU size and a processing amount of an orthogonal transform process.

FIG. 9 is a block diagram illustrating an example of a schematic configuration of an image encoding device.

FIG. 10 is a block diagram illustrating a first example of detailed configurations of an intra prediction section and an inter prediction section.

FIG. 11 is a block diagram illustrating a first example of a detailed configuration of an orthogonal transform section.

FIG. 12 is a flowchart illustrating an example of the flow of a CU/PU size search process related to FIG. 10.

FIG. 13 is a block diagram illustrating a second example of detailed configurations of an intra prediction section and an inter prediction section.

FIG. 14 is a block diagram illustrating a second example of a detailed configuration of an orthogonal transform section.

FIG. 15 is a flowchart illustrating an example of the flow of a CU/PU size search process related to FIG. 13.

FIG. 16 is a block diagram illustrating a third example of a detailed configuration of an orthogonal transform section.

FIG. 17 is a block diagram illustrating an overview of the flow of a transcoding process between AVC and HEVC.

FIG. 18A illustrates a first half of a table including a list of examples of block sizes that can be supported in respective embodiments.

FIG. 18B illustrates a second half of a table including a list of examples of block sizes that can be supported in respective embodiments.

FIG. 19 is a block diagram illustrating an example of a hardware configuration of an encoder.

FIG. 20 is a block diagram illustrating an example of a schematic configuration of a mobile phone.

FIG. 21 is a block diagram illustrating an example of a schematic configuration of a recording/reproduction device.

FIG. 22 is a block diagram illustrating an example of a schematic configuration of an image capturing device.

FIG. 23 is a block diagram illustrating an example of a schematic configuration of a video set.

FIG. 24 is a block diagram illustrating an example of a schematic configuration of a video processor.

FIG. 25 is a block diagram illustrating another example of a schematic configuration of a video processor.

### DESCRIPTION OF EMBODIMENT(S)

Hereinafter, (a) preferred embodiment(s) of the present disclosure will be described in detail with reference to the appended drawings. In this specification and the drawings, elements that have substantially the same function and structure are denoted with the same reference signs, and repeated explanation is omitted.

Description will proceed in the following order.

1. Various blocks in HEVC

1-1. Block division

1-2. Block scan order

1-3. Others

2. Exemplary configuration of encoder

2-1. Overall configuration

2-2. First embodiment

2-3. Second embodiment

2-4. Third embodiment

2-5. Modified example

3. Exemplary hardware configuration

4. Application examples

4-1. Applications to various products

4-2. Various implementation levels

5. Conclusion

### 1. VARIOUS BLOCKS IN HEVC

### 1-1. Block Division

### (1) Recursive CU Division

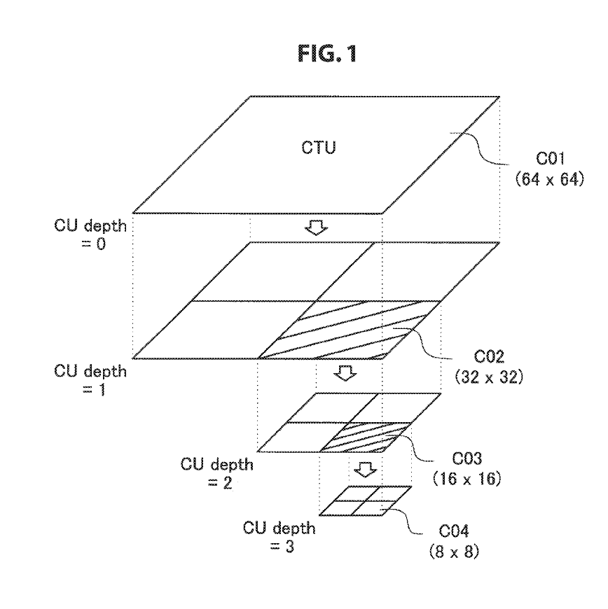

FIG. 1 is an explanatory view for describing an overview of recursive block division on a CU in HEVC. The block division of the CU is performed by recursively repeating division of one block into four (=2×2) sub blocks, and a tree structure of a quad-tree form is consequently formed. One entire quad tree corresponds to a coding tree block (CTB), and a logical unit corresponding to a CTB is called a coding tree unit (CTU). An upper portion of FIG. 1 illustrates a CU C01 having a size of 64×64 pixels as an example. A division depth of the CU C01 is equal to zero. This indicates that the CU C01 is a CTU root and corresponds to an LCU. The LCU size may be designated by a parameter encoded in a sequence parameter set (SPS) or a picture parameter set (PPS). A CU C02 is one of four CUs obtained by dividing the CU C01 and has a size of 32×32 pixels. A division depth of the CU C02 is equal to “1.” A CU C03 is one of four CUs obtained by dividing the CU C02 and has a size of 16×16 pixels. A division depth of the CU C03 is equal to “2.” A CU C04 is one of four CUs obtained by dividing the CU C03 and has a size of 8×8 pixels. A division depth of the CU C03 is equal to “3.” As described above, the CU is formed by recursively dividing an image to be encoded. The division depth is variable. For example, a CU having a large size (that is, a small depth) may be set to a flat image region such as the blue sky. On the other hand, a CU having a small size (that is, a large depth) may be set to a steep image region having many edges. Each of the set CUs is used as the processing unit of the encoding process.

### (2) Setting of PU in CU

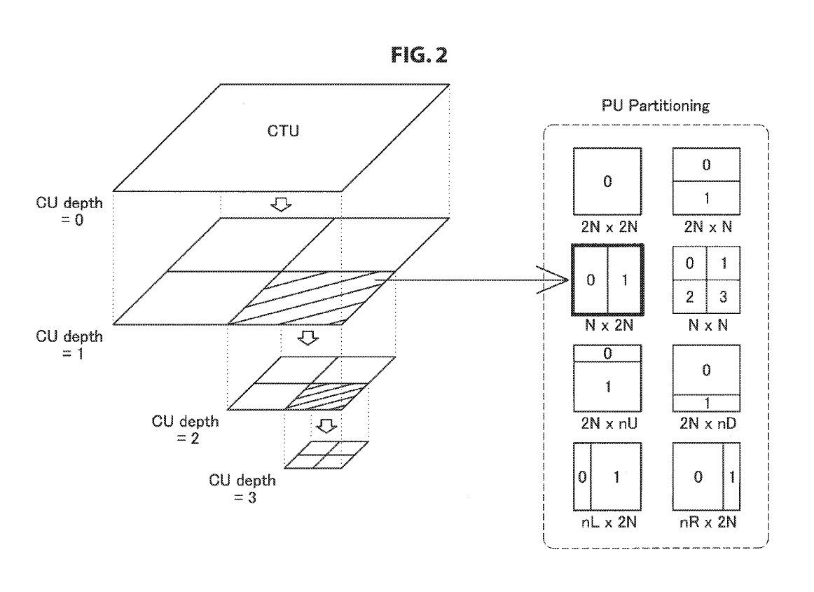

The PU is the processing unit of the prediction process including the intra prediction and the inter prediction. The PU is formed by dividing a CU by one of several division patterns. FIG. 2 is an explanatory view for describing a setting of the PU in the CU illustrated in FIG. 1. Eight types of division patterns such as 2N×2N, 2N×N, N×2N, N×N, 2N×nU, 2N×nD, nL×2N, and nR×2N are illustrated in the right of FIG. 2. In the intra prediction, two types, that is, 2N×2N and N×N, among the division patterns are selectable (N×N is selectable only in the SCU). On the other hand, in the inter prediction, when asymmetric motion division is enabled, all eight types of division patterns are selectable.

### (3) Setting of TU in CU

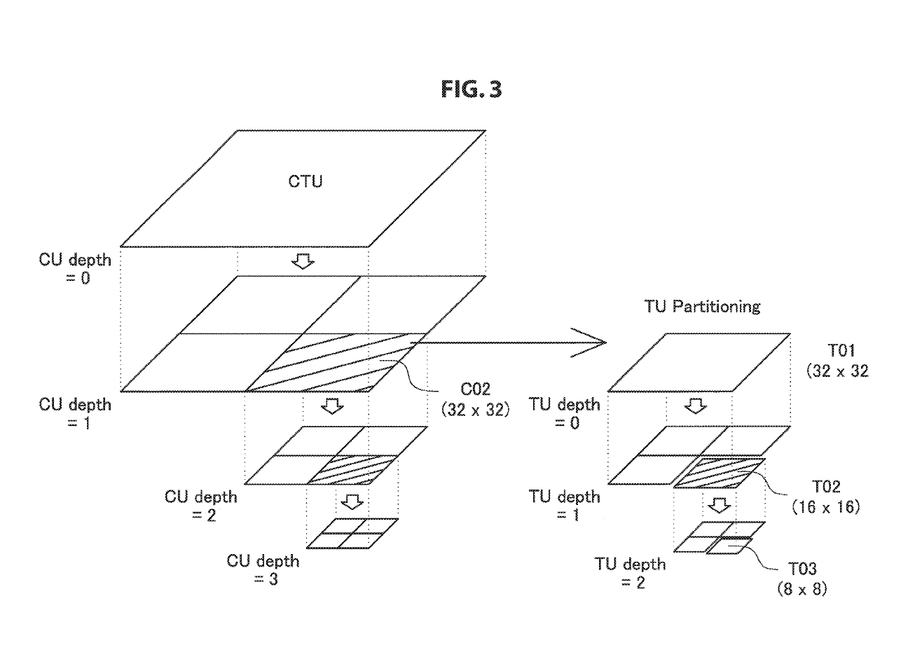

The TU is the processing unit of an orthogonal transform process. The TU is formed by dividing the CU (each PU in the CU for the intra CU) up to a certain depth. FIG. 3 is an explanatory view for describing a setting of the TU in the CU illustrated in FIG. 1. One or more TUs that can be set in the CU C02 are illustrated on the right of FIG. 3. For example, a TU T01 has a size of 32×32 pixels, and a TU division depth thereof is equal to zero. A TU T02 has a size of 16×16 pixels, and a TU division depth thereof is equal to “1.” A TU T03 has a size of 8×8 pixels, and a TU division depth thereof is equal to “2.”

A block division that is performed to set the blocks such as the CUs, the PUs, or the TUs to an image is typically decided based on a comparison of the costs having influence on the coding efficiency. For example, an encoder compares the cost of one CU of 2M×2M pixels with the cost of four CUs of M×M pixels, and decides to divide one CU of 2M×2M pixels into four CUs of M×M pixels when a setting of four CUs of M×M pixels is higher in the coding efficiency. However, the number of types of block sizes selectable in HEVC is dramatically larger than in the known image coding schemes. When the number of types of selectable block sizes is large, it means that the number of combinations of block sizes whose costs are compared to find an optimum block size is large. In contrast, a block size of a macroblock (serving as the processing unit of the encoding process) in AVC is limited to 16×16 pixels. A block size of a prediction block in AVC is variable, but an upper limit of the size is 16×16 pixels. A block size of a transform block in AVC is 4×4 pixels or 8×8 pixels. An increase in the number of types of block sizes selectable in HEVC imposes requirements that more information has to be processed rapidly within a limited period of time on the encoder, and thus the implementation cost of the encoder increases.

### 1-2. Block Scan Order

### (1) Scan Order of CU/PU

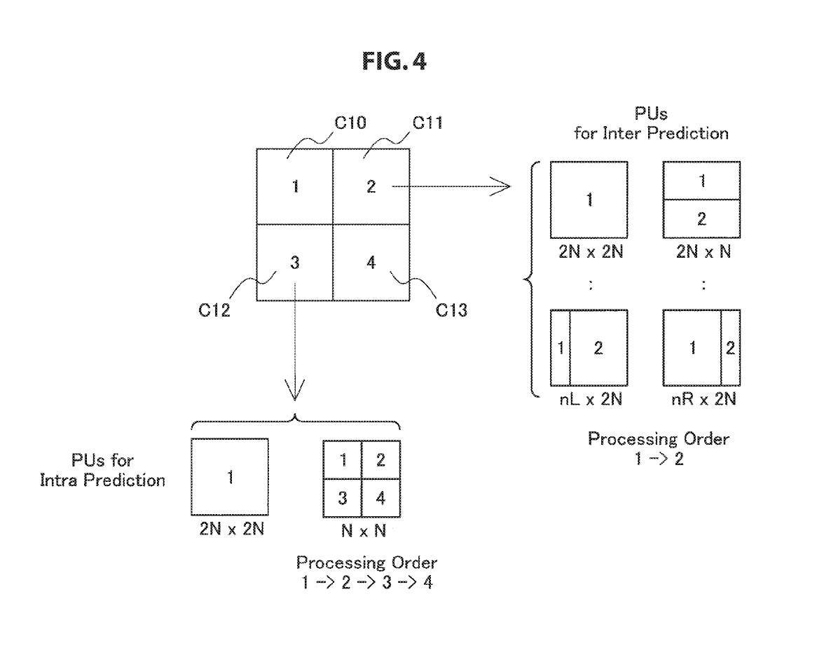

When an image is encoded, the CTBs (or the LCUs) set in a lattice form in an image (or a slice or a tile) are scanned in a raster scan order. In one CTB, the CUs are scanned to trace the quad tree from left to right and from top to bottom. When a current block is processed, information of upper and left neighboring blocks is used as input information. FIG. 4 is an explanatory view for describing scan orders of the CU and the PU. Four CUs C10, C11, C12 and C13 that can be included in one CTB are illustrated in the upper left portion of FIG. 4. A number in a frame of each CU indicates a place in a processing order. The encoding process is performed in the order of the upper left CU C10, the upper right CU C11, the lower left CU C12, and the lower right CU C13. One or more PUs for the inter prediction that can be set to the CU C11 are illustrated on the right of FIG. 4. One or more PUs for the intra prediction that can be set to the CU C12 are illustrated on the lower portion of FIG. 4. As indicated by the numbers in the frames of the PUs, the PUs are also scanned from left to right and from top to bottom. When one block is divided into more sub blocks, the number of sub blocks to be serially scanned increases, and thus clocks of the processing circuit become tight, and the number of memory accesses increases as well. Thus, the block division into the smaller block can also be one cause of the increase in the performance requirements for the encoder.

### (2) Reference to Neighboring Block

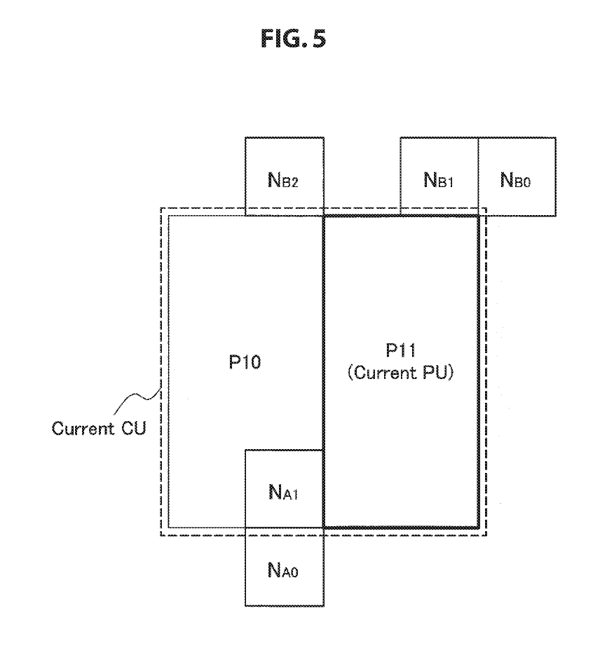

The inter prediction of HEVC has a mechanism called adaptive motion vector prediction (AMVP). In AMVP, in order to reduce the code amount of the motion vector information, the motion vector information of a current PU undergoes the predictive encoding based on the motion vector information of a neighboring PU. FIG. 5 is an explanatory view for describing reference to a neighboring PU in the inter prediction process. In an example of FIG. 5, two PUs P10 and P11 are set in a current CU. The PU P11 is a current PU. In AMVP of the inter prediction process for the PU P11, motion vectors set to left neighboring blocks N_{A0} and N_{A1} and upper neighboring blocks N_{B0}, N_{B1}, and N_{B2} are referred to as candidates for a predictive motion vector. Thus, the inter prediction process for the PU P11 is performed after being on standby until the inter prediction process for the upper and left neighboring blocks end.

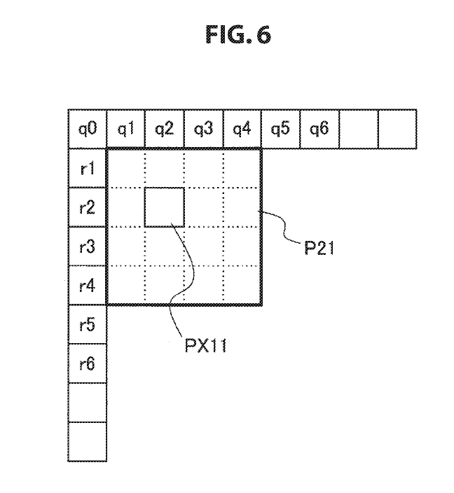

In the intra prediction of HEVC, a predicted pixel value of a current PU is calculated using a reference pixel value of a neighboring PU. FIG. 6 is an explanatory view for describing reference to the neighboring PU in an intra prediction process. In the example of FIG. 6, a PU P21 is a current PU. A pixel PX11 is a pixel belonging to the PU P11. On the other hand, pixels q0 to q6 are reference pixels belonging to upper neighboring PUs, and pixels r1 to r6 are reference pixels belonging to left neighboring PUs. For example, a predicted pixel value of the pixel PX11 in intra DC prediction is equal to pixel values of reference pixels q1, q2, q3, q4, r1, r2, r3, and r4.

The reference relation between blocks described above with reference to FIGS. 5 and 6 is also one cause of the increase in the performance requirements for the encoder when one block is divided into more blocks. For example, since it is difficult to start the process for a current block before the process for a neighboring block ends, clocks of the processing circuit may become tight. Further, the number of accesses to the buffer that holds the pixel values of the neighboring blocks may depend on the number of times that the reference pixel is used.

### 1-3. Others

### (1) Relation Between CU Size and Memory Requirements

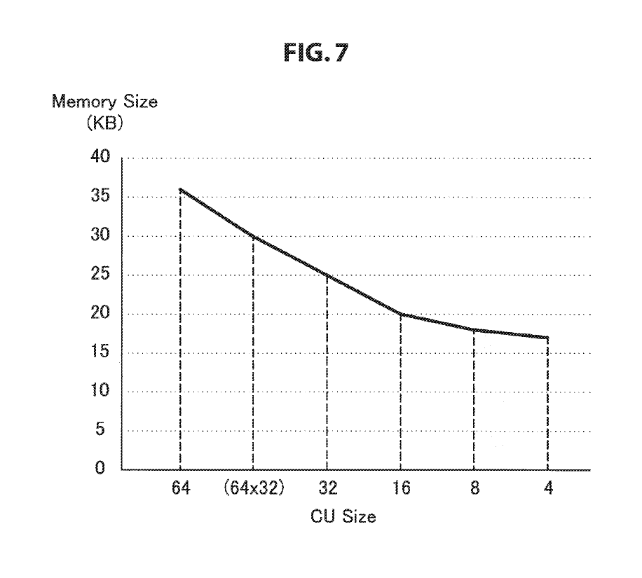

In the inter prediction, the encoder may hold reference pixel values in a search region of motion search in an on-chip memory. As the block size of the current PU increases, the search region of the motion search increases. For example, when a PU size is assumed to be M×M pixels, and upper left pixel position of a current PU is assumed to be (0,0), reference pixel values in a rectangular region having pixel positions (−M,−M) and (2M,2M) as apexes are buffered. FIG. 7 illustrates an example of a relation between a CU size and memory capacity requirements under this condition. In the graph of FIG. 7, a horizontal axis indicates a CU size, and a vertical axis indicates memory capacities that may require individual CU sizes. As can be understood from the graph, a difference in a required memory capacity among the CU sizes of 4×4 pixels, 8×8 pixels, and 16×16 pixels is smaller than 5 KB, whereas a required memory capacity of the CU size of 64×64 pixels is 10 KB or more larger than that of 32×32 pixels and 15 KB or more larger than that of 16×16 pixels.

### (2) Relation Between TU Size and Processor Requirements

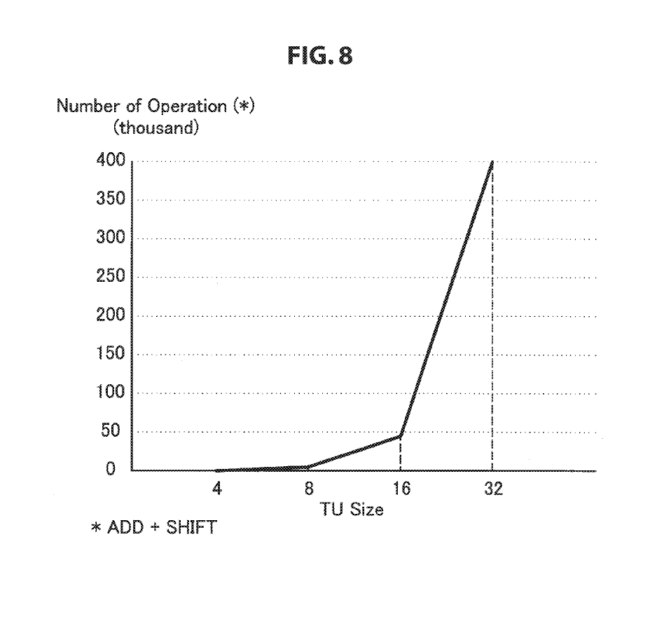

Several literatures in which a relation between a TU size and processor requirements are described are known (for example, see “A low energy HEVC Inverse DCT hardware” (Ercan Kalali, Erdem Ozcan, Ozgun Mert Yalcinkaya, Ilker Hamzaoglu, Consumer Electronics, ICCE Berlin 2013, IEEE, Sep. 9-11, 2013), and “Comparison of the coding efficiency of video coding standards—Including High Efficiency Video Coding (HEVC)” (J. R. Ohm, G. J. Sullivan, H. Schwarz, T. K. Tan and T. Wiegand, Circuits and Systems for Video Technology, IEEE, December, 2012)). FIG. 8 illustrates an example of a relation between a TU size and a processing amount of the orthogonal transform process based on data presented in the literature “A low energy HEVC Inverse DCT hardware.” In the graph of FIG. 8, a horizontal axis indicates a TU size, and a vertical axis indicates a total of the number of ADD operations and SHIFT operations performed in the orthogonal transform process for TUs of corresponding sizes. Generally speaking, when one side of a TU is doubled, the number of operations is increased tenfold. As can be understood from FIG. 8, the orthogonal transform process for a TU of 32×32 pixels requires about 350,000 times as many operations as the orthogonal transform process for a TU having a smaller size.

Based on the consideration described above with reference to FIGS. 1 to 8, in exemplary embodiments of the technology according to the present disclosure, instead of comprehensively searching all selectable block sizes, some block sizes are excluded from the search range. Since the search range of the block size is reduced, the performance requirements for the encoder are effectively relaxed, and the implementation cost is reduced. An exemplary configuration of the encoder for implementing such a mechanism will be described in the next section.

### 2. EXEMPLARY CONFIGURATION OF ENCODER

### 2-1. Overall Configuration

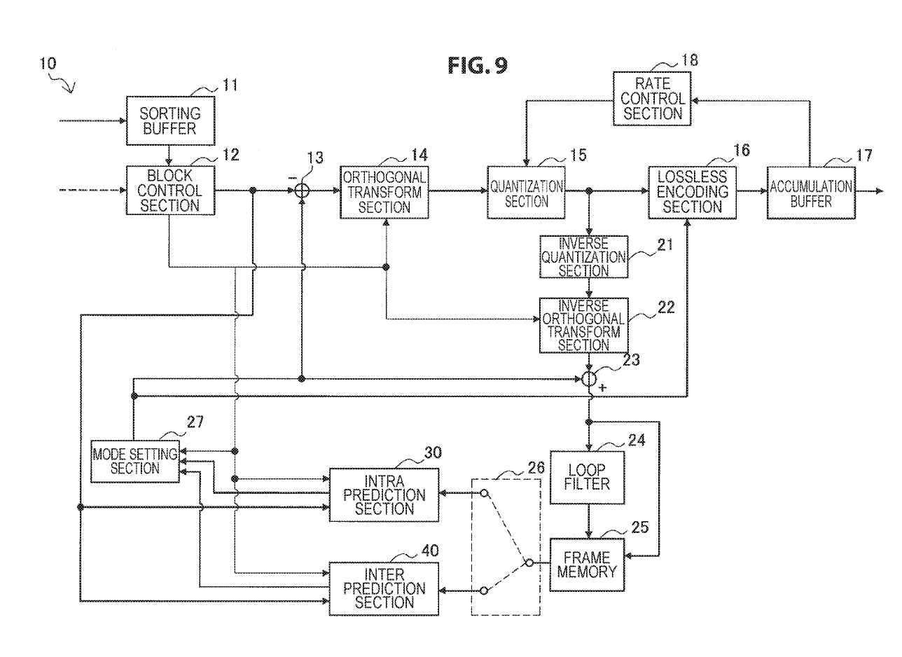

FIG. 9 is a block diagram illustrating an example of a schematic configuration of an image encoding device 10. Referring to FIG. 9, the image encoding device 10 includes a sorting buffer 11, a block control section 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a loop filter 24, a frame memory 25, a switch 26, a mode setting section 27, an intra prediction section 30, and an inter prediction section 40.

The sorting buffer 11 sorts images included in a series of image data. After sorting the images according to a GOP (Group of Pictures) structure according to the encoding process, the sorting buffer 11 outputs the image data which has been sorted to the block control section 12.

The block control section 12 controls a block-based encoding process in the image encoding device 10. For example, the block control section 12 sequentially sets the CTB in the images input from the sorting buffer 11 according to the LCU size. Then, the block control section 12 outputs the image data to the subtraction section 13, the intra prediction section 30 and the inter prediction section 40 in units of CTBs. The block control section 12 causes the intra prediction section 30 and the inter prediction section 40 to perform the prediction process and causes the mode setting section 27 to determine the block division and the prediction mode optimum for each CTB. The block control section 12 may generate a parameter indicating the optimum block division and cause the lossless encoding section 16 to encode the generated parameter. The block control section 12 may variably control the search range of the block division depending on auxiliary information (an arrow of a dotted line in FIG. 9) such as setting information registered in advance by the user or performance information of the encoder.

The subtraction section 13 calculates predicted error data serving as a difference between image data input from the block control section 12 and predicted image data, and outputs the calculated predicted error data to the orthogonal transform section 14.

The orthogonal transform section 14 performs the orthogonal transform process on each of one or more TUs set to the image. For example, the orthogonal transform may be a discrete cosine transform (DCT) or a Karhunen-Loeve transform, or the like. More specifically, the orthogonal transform section 14 transfers the predicted error data input from the subtraction section 13 from an image signal in a space domain to transform coefficient data in a frequency domain in units of TUs. The TU sizes selectable in the HEVC specification include 4×4 pixels, 8×8 pixels, 16×16 pixels, and 32×32 pixels, but in an example to be described later, the search range of the TU size can be reduced to a narrower range under control of the block control section 12. The orthogonal transform section 14 outputs the transform coefficient data acquired by the orthogonal transform process to the quantization section 15.

The quantization section 15 is supplied with the transform coefficient data input from the orthogonal transform section 14 and a rate control signal from the rate control section 18 to be described below. The quantization section 15 quantizes the transform coefficient data with the quantization step decided according to the rate control signal. The quantization section 15 outputs the quantized transform coefficient data (hereinafter referred to as “quantized data”) to the lossless encoding section 16 and the inverse quantization section 21.

The lossless encoding section 16 generates an encoded stream by encoding the quantized data input from the quantization section 15 for each of CUs formed by recursively dividing an image to be encoded. The CU sizes selectable in the HEVC specification include 8×8 pixels, 16×16 pixels, 32×32 pixels, and 64×64 pixels, but in an example to be described later, the search range of the CU size is reduced to a narrower range under the control of the block control section 12. For example, the lossless encoding section 16 performs the encoding process according to the block size (the CU size, the PU size, or the TU size) set by the mode setting section 27. The lossless encoding section 16 encodes various parameters that are referred to by a decoder, and inserts the encoded parameters into the header region of the encoded stream. The parameters encoded by the lossless encoding section 16 may include block division information indicating how the CU, the PU, or the TU is set in an image (block division to be performed). Then, the lossless encoding section 16 outputs the generated encoded stream to the accumulation buffer 17.

The accumulation buffer 17 temporarily accumulates an encoded stream input from the lossless encoding section 16 using a storage medium such as a semiconductor memory. Then, the accumulation buffer 17 outputs the accumulated encoded stream to a transmission section (not shown) (for example, a communication interface or an interface to peripheral devices) at a rate in accordance with the band of a transmission path.

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21, the inverse orthogonal transform section 22, and the addition section 23 form a local decoder. In the quantization step used by the quantization section 15, the inverse quantization section 21 performs inverse quantization on the quantized data to thereby restore the transform coefficient data. Then, the inverse quantization section 21 outputs the restored transform coefficient data to the inverse orthogonal transform section 22.

The inverse orthogonal transform section 22 performs an inverse orthogonal transform process on the transform coefficient data input from the inverse quantization section 21 to thereby restore the predicted error data. As in the orthogonal transform, the inverse orthogonal transform is performed for each TU. Then, the inverse orthogonal transform section 22 outputs the restored predicted error data to the addition section 23.

The addition section 23 adds the restored predicted error data input from the inverse orthogonal transform section 22 and the predicted image data input from the intra prediction section 30 or the inter prediction section 40 to thereby generate decoded image data (reconstructed image). Then, the addition section 23 outputs the generated decoded image data to the loop filter 24 and the frame memory 25.

The loop filter 24 includes a group of filters such as a deblock filter (DF) and a sample adaptive offset (SAO) filter used for improving the image quality. The loop filter 24 filters decoded image data input from the addition section 23, and outputs the filtered decoded image data to the frame memory 25.

The frame memory 25 stores the decoded image data before the filtering input from the addition section 23, the decoded image data after the filtering input from the loop filter 24 using a storage medium.

The switch 26 reads the decoded image data before the filtering used for the intra prediction from the frame memory 25 and supplies the read decoded image data as reference image data to the intra prediction section 30. Further, the switch 26 reads the filtered decoded image data used for the inter prediction from the frame memory 25 and supplies the read decoded image data as reference image data to the inter prediction section 40.

The mode setting section 27 determines the block division and the prediction mode optimum for each CTB based on a comparison of the costs input from the intra prediction section 30 and the inter prediction section 40. Then, the mode setting section 27 sets the block size such as the CU, the PU, or the TU according to a determination result. More specifically, in the present embodiment, the mode setting section 27 sets the block size of the blocks such as the CU and the PU and the TU set in the CU according to the search range from which one or more smallest candidate sizes among all candidate sizes are excluded. One or more largest candidate sizes among all candidate sizes may be further excluded from the search range of the block size. Here, “all candidate sizes” mean all sizes defined to be available in a specification of a coding scheme (for example, HEVC) with which the image encoding device 10 complies. Further, “excluded” means that a specific candidate size is not included as a search target of a block size. As an example, the search range of the block size may be a fixed range narrower than a perfect search range (defined in a standard specification) including all candidate sizes. As another example, a narrower search range of the block size may be dynamically set by excluding some candidate sizes from the perfect search range. For the blocks in which the intra prediction mode is selected, the mode setting section 27 outputs the predicted image data generated by the intra prediction section 30 to the subtraction section 13, and outputs information related to the intra prediction to the lossless encoding section 16. For the blocks in which the inter prediction mode is selected, the mode setting section 27 outputs the predicted image data generated by the inter prediction section 40 to the subtraction section 13, and outputs information related to the inter prediction to the lossless encoding section 16.

The intra prediction section 30 performs the intra prediction process on each of one or more PUs set in the CU based on the original image data and the decoded image data. For example, the intra prediction section 30 evaluates the prediction result in each candidate mode in the prediction mode set using a predetermined cost function. Then, the intra prediction section 30 selects a prediction mode in which the cost is smallest, that is, a prediction mode in which the compression ratio is highest, as an optimum mode. The intra prediction section 30 generates the predicted image data according to the optimum mode. Then, the intra prediction section 30 outputs the information related to the intra prediction indicating the optimum mode, the cost, and the predicted image data to the mode setting section 27. In an example to be described later, the search range of the PU size is reduced to a narrower range than the perfect search range defined in the HEVC specification under the control of the block control section 12.

The inter prediction section 40 performs the inter prediction process on each of one or more PUs set in the CU based on the original image data and the decoded image data. For example, the inter prediction section 40 evaluates the prediction result in each candidate mode in the prediction mode set using a predetermined cost function. Then, the inter prediction section 40 selects a prediction mode in which the cost is smallest, that is, a prediction mode in which the compression ratio is highest, as an optimum mode. The inter prediction section 40 generates the predicted image data according to the optimum mode. Then, the inter prediction section 40 outputs the information related to the inter prediction indicating the optimum mode, the cost, and the predicted image data to the mode setting section 27. In an example to be described later, the search range of the PU size is reduced to a narrower range than the perfect search range defined in the HEVC specification under the control of the block control section 12.

In the image encoding device 10 having the configuration illustrated in FIG. 9, the reduction in the search range of the block size may be performed by various techniques. In first and second embodiments to be described below, the search range of at least one size of the CU and the PU does not include one or more smallest candidate sizes among a plurality of selectable candidate sizes. Here, the selectable size refers to a size defined to be available in a specification of a coding scheme (for example, HEVC) with which the image encoding device 10 complies. Further, one or more largest candidate sizes may be excluded from the search range. In the second embodiment, the search range of the PU size is restricted to the same size as the CU. The search range of the TU size may also be restricted to the same size as the CU. In a third embodiment, the search range of the TU size does not include one or more largest candidate sizes among a plurality of selectable candidate sizes.

### 2-2. First Embodiment

In the first embodiment, first, in order to relax the memory capacity requirements of the on-chip memory of the encoder, the CU size and the PU size exceeding 32×32 pixels are assumed to be excluded from the search range of the block size. Further, in order to relax requirements for a processing logic and reduce the number of memory accesses, the CU size of 8×8 pixels and the PU size of 4×4 pixels are also assumed to be excluded from the search range of the block size.

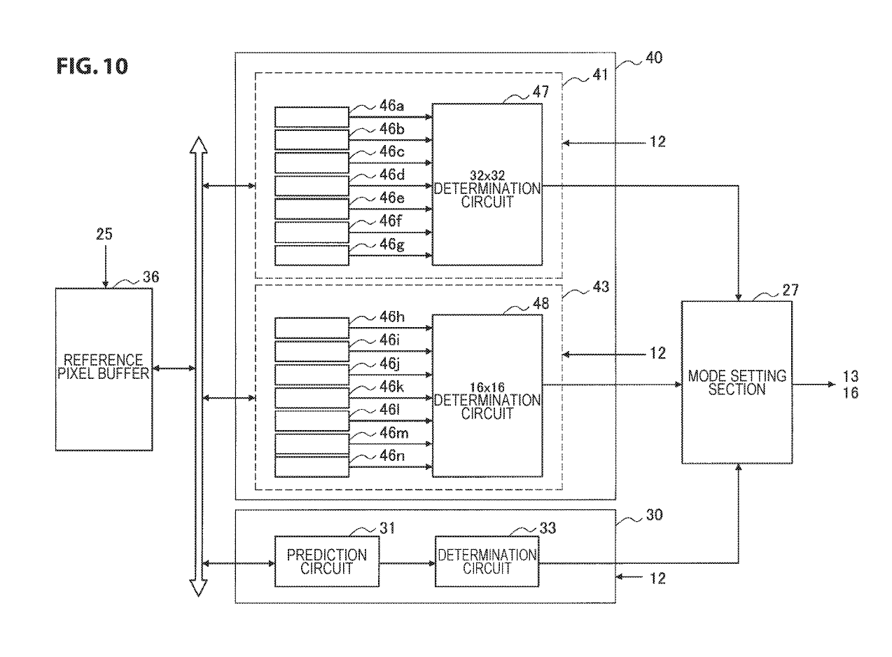

FIG. 10 is a block diagram illustrating a first example of detailed configurations of the intra prediction section 30 and the inter prediction section 40. Referring to FIG. 10, the intra prediction section 30 includes a prediction circuit 31 and a determination circuit 33. The prediction circuit 31 performs the intra prediction process according to a plurality of candidate modes for each of the PU sizes included in the reduced search range and generates the predicted image corresponding to each combination of the PU size and the candidate mode under the control of the block control section 12. The prediction circuit 31 may calculate the predicted pixel value of the current PU using the reference pixel value of the neighboring PU buffered in a reference image buffer 36. Here, three types of PU sizes, for example, 8×8 pixels, 16×16 pixels, and 32×32 pixels, may be included in the search range. The determination circuit 33 calculates the costs of combinations of the PU size and the candidate mode, and determines a combination of the PU size and the candidate mode in which the calculated cost is smallest. Then, the determination circuit 33 outputs the predicted image, the cost, and the mode information corresponding to the determined optimum combination to the mode setting section 27.

Referring to FIG. 10, the inter prediction section 40 includes a 32×32 inter process engine 41 and a 16×16 inter process engine 43. The 32×32 inter process engine 41 includes a 32×32 prediction circuit 46a, a 16×32 prediction circuit 46b, a 32×16 prediction circuit 46c, a 32×8 prediction circuit 46d, a 24×32 prediction circuit 46e, an 8×32 prediction circuit 46f, a 32×24 prediction circuit 46g, and a 32×32 determination circuit 47. The 32×32 prediction circuit 46a performs the inter prediction process with the PU size of 32×32 pixels, and generates a predicted image of 32×32 pixels. The 16×32 prediction circuit 46b performs the inter prediction process with the PU size of 16×32 pixels, and generates a predicted image of 16×32 pixels. The 32×16 prediction circuit 46c performs the inter prediction process with the PU size of 32×16 pixels, and generates a predicted image of 32×16 pixels. The 32×8 prediction circuit 46d performs the inter prediction process with the PU size of 32×8 pixels, and generates a predicted image of 32×8 pixels. The 24×32 prediction circuit 46e performs the inter prediction process with the PU size of 24×32 pixels, and generates a predicted image of 24×32 pixels. The 8×32 prediction circuit 46f performs the inter prediction process with the PU size of 8×32 pixels, and generates a predicted image of 8×32 pixels. The 32×24 prediction circuit 46g performs the inter prediction process with the PU size of 32×24 pixels, and generates a predicted image of 32×24 pixels. When the predicted images are generated, the reference pixel value of the reference frame buffered in the reference image buffer 36 may be referred to for a calculation of the predicted pixel value of the current PU. The 32×32 determination circuit 47 calculates the costs of the PU division patterns illustrated in FIG. 2 using the generated predicted image and the original image, and determines a division pattern in which the calculated cost is smallest. Then, the 32×32 determination circuit 47 outputs the predicted image, the cost, and the mode information corresponding to the determined optimum division patterns to the mode setting section 27.

The 16×16 inter process engine 43 includes a 16×16 prediction circuit 46h, an 8×16 prediction circuit 46i, a 16×8 prediction circuit 46j, a 16×4 prediction circuit 46k, a 12×16 prediction circuit 46l, a 4×16 prediction circuit 46m, a 16×12 prediction circuit 46n, and a 16×16 determination circuit 48. The 16×16 prediction circuit 46h performs the inter prediction process with the PU size of 16×16 pixels, and generates a predicted image of 16×16 pixels. The 8×16 prediction circuit 46i performs the inter prediction process with the PU size of 8×16 pixels, and generates a predicted image of 8×16 pixels. The 16×8 prediction circuit 46j performs the inter prediction process with the PU size of 16×8 pixels, and generates a predicted image of 16×8 pixels. The 16×4 prediction circuit 46k performs the inter prediction process with the PU size of 16×4 pixels, and generates a predicted image of 16×4 pixels. The 12×16 prediction circuit 46l performs the inter prediction process with the PU size of 12×16 pixels, and generates a predicted image of 12×16 pixels. The 4×16 prediction circuit 46m performs the inter prediction process with the PU size of 4×16 pixels, and generates a predicted image of 4×16 pixels. The 16×12 prediction circuit 46n performs the inter prediction process with the PU size of 16×12 pixels, and generates a predicted image of 16×12 pixels. When the predicted images are generated, the reference pixel value of the reference frame buffered in the reference image buffer 36 may be referred to for a calculation of the predicted pixel value of the current PU. The 16×16 determination circuit 48 calculates the costs of the PU division patterns illustrated in FIG. 2 using the generated predicted image and the original image, and determines a division pattern in which the calculated cost is smallest. Then, the 16×16 determination circuit 48 outputs the predicted image, the cost, and the mode information corresponding to the determined optimum division patterns to the mode setting section 27.

In order to set the block size, the mode setting section 27 compares the costs input from the determination circuit 33, the 32×32 determination circuit 47, and the 16×16 determination circuit 48, and determines the block division and the prediction mode optimum for each CTB. For example, when the cost input from the 32×32 determination circuit 47 is smallest, the CU size of 32×32 pixels and the inter prediction mode corresponding thereto may be selected. When the cost input from the 16×16 determination circuit 48 is smallest, the CU size of 16×16 pixels and the inter prediction mode corresponding thereto may be selected. When the cost input from the determination circuit 33 is smallest, the CU size selected by the determination circuit 33 and the intra prediction mode corresponding thereto may be selected.

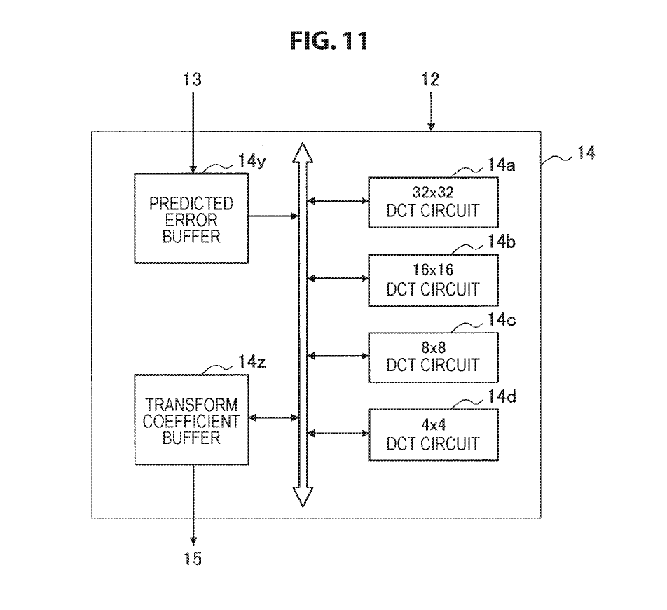

FIG. 11 is a block diagram illustrating a first example of a detailed configuration of the orthogonal transform section 14. Referring to FIG. 11, the orthogonal transform section 14 includes a 32×32 DCT circuit 14a, a 16×16 DCT circuit 14b, an 8×8 DCT circuit 14c, a 4×4 DCT circuit 14d, a predicted error buffer 14y, and a transform coefficient buffer 14z. The 32×32 DCT circuit 14a performs the orthogonal transform process on the predicted error data buffered in the predicted error buffer 14y with the TU size of 32×32 pixels, and stores the transform coefficient data in the transform coefficient buffer 14z. The 16×16 DCT circuit 14b performs the orthogonal transform process on the predicted error data buffered in the predicted error buffer 14y with the TU size of 16×16 pixels, and stores the transform coefficient data in the transform coefficient buffer 14z. The 8×8 DCT circuit 14c performs the orthogonal transform process on the predicted error data buffered in the predicted error buffer 14y with the TU size of 8×8 pixels, and stores the transform coefficient data in the transform coefficient buffer 14z. The 4×4 DCT circuit 14d performs the orthogonal transform process on the predicted error data buffered in the predicted error buffer 14y with the TU size of 4×4 pixels, and stores the transform coefficient data in the transform coefficient buffer 14z. In HEVC, in the CU in which the inter prediction mode is selected (the inter CU), a parent node of the block division of the TU is the CU. On the other hand, in the CU in which the intra prediction mode is selected (the intra CU), a parent node of the block division of the TU is the PU. The block division optimum for the TU may also be determined based on the cost comparison in the mode setting section 27.

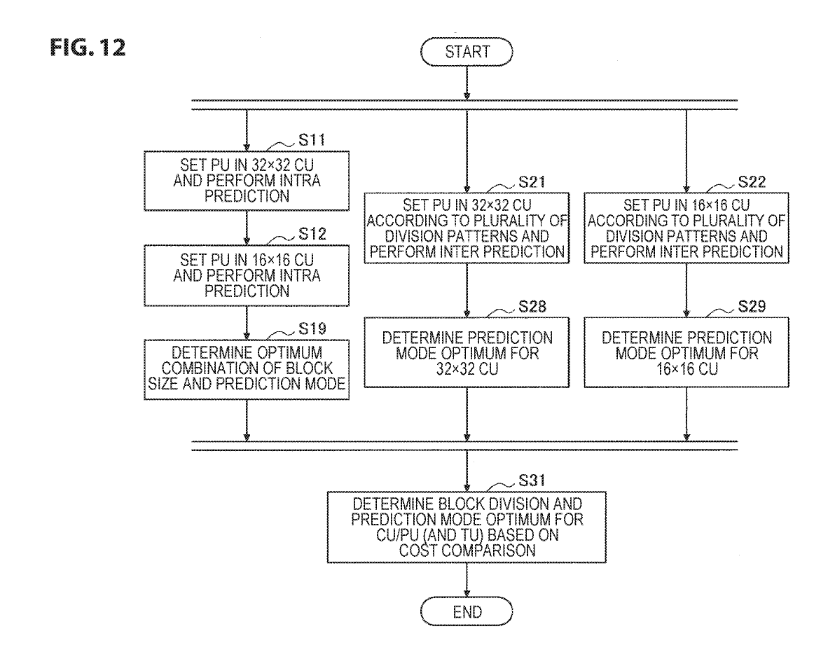

FIG. 12 is a flowchart illustrating an example of the flow of the CU/PU size search process related to FIG. 10. An order of process steps in a flowchart described in this specification is merely an example. In other words, several illustrated process steps may be performed in a different order regardless of whether they are performed in serial or in parallel. Further, some of several illustrated process steps may be omitted, or an additional process step may be employed. Referring to FIG. 12, the intra prediction process (step S11, S12 and S19), the inter prediction process (step S21 and S28) for the CU of 32×32 pixels, and the inter prediction process (step S22 and S29) for the CU of 16×16 pixels are illustrated as being performed in parallel.

In the intra prediction process, first, the intra prediction section 30 sets the PU in the CU of 32×32 pixels, and performs the intra prediction on the set PU (step S11). Then, the intra prediction section 30 sets the PU in the CU of 16×16 pixels, and performs the intra prediction on the set PU (step S12). One PU of 16×16 pixels or four PUs of 8×8 pixels may be set in the CU of 16×16 pixels. Then, the intra prediction section 30 determines an optimum combination of the block size and the prediction mode (step S19).

In the inter prediction process of the CU of 32×32 pixels, first, the 32×32 inter process engine 41 sets one or more PUs in the CU of 32×32 pixels according to a plurality of division patterns, and performs the inter prediction on each of the PUs (using the prediction circuit corresponding to the PU size) (step S21). Then, the 32×32 inter process engine 41 determines a prediction mode optimum for the CU of 32×32 pixels (step S28).

In the inter prediction process of the CU of 16×16 pixels, first, the 16×16 inter process engine 43 sets one or more PUs in the CU of 16×16 pixels according to a plurality of division patterns, and performs the inter prediction on each of the PUs (using the prediction circuit corresponding to the PU size) (step S22). Then, the 16×16 inter process engine 43 determines a prediction mode optimum for the CU of 16×16 pixels (step S29).

Then, the mode setting section 27 determines the block division and the prediction mode optimum for the CU/PU (and the TU) based on the cost comparison (step S31).

As described above, in the first embodiment, the search range of the CU size does not include 8×8 pixels. The search range of the PU size does not include 4×4 pixels either. Thus, since the block sizes are not searched, it is possible to reduce the processing cost, increase the processing speed, and reduce the circuit size. The search range reduction may be applied to one of the CU size and the PU size. Since the search range is reduced starting from the smallest size among a plurality of selectable candidate sizes, a risk of the number of sub blocks that are serially scanned in a certain block increasing excessively is prevented. As a result, there is room between clocks of the processing circuit, and the number of memory accesses can be reduced. Accordingly, the performance requirements for the encoder are relaxed.

In the first embodiment, the search range of the CU size does not include 64×64 pixels. In other words, the search range of the CU size is also reduced starting from the largest size among a plurality of selectable candidate sizes. As a result, since the maximum size of the reference block to be held in the on-chip memory is reduced, the memory capacity requirements required in the encoder are relaxed.

### 2-3. Second Embodiment

In the second embodiment, in order to further relax the requirements for the processing logic and further reduce the number of memory accesses, the PU size and the TU size are assumed to be restricted to the same size as the CU size. This technique is useful for applications to mobile devices such as smart phones, tablet PCs, and laptop PCs having strict power consumption requirements.

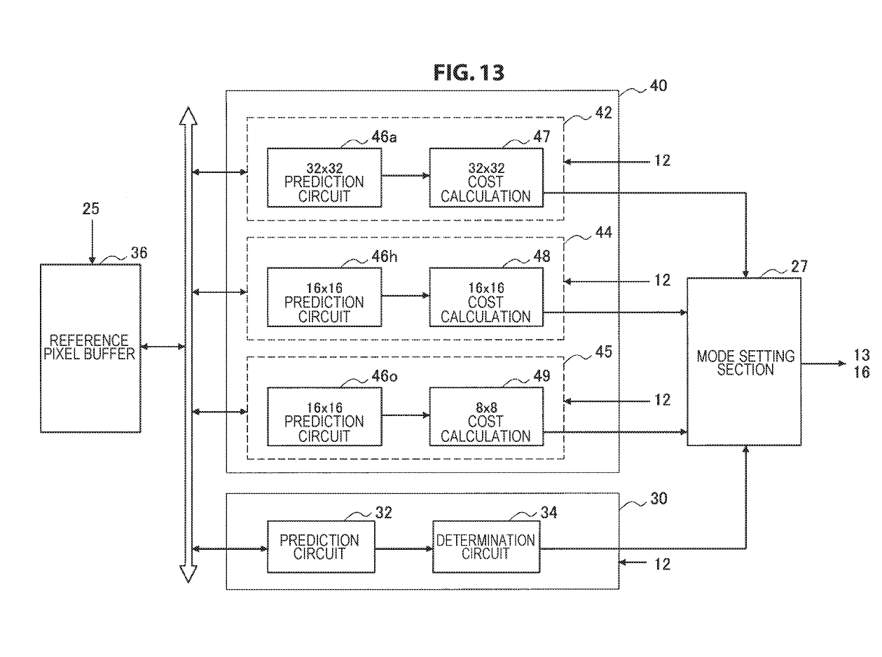

FIG. 13 is a block diagram illustrating a second example of detailed configurations of the intra prediction section 30 and the inter prediction section 40. Referring to FIG. 13, the intra prediction section 30 includes a prediction circuit 32 and a determination circuit 34. The prediction circuit 32 performs the intra prediction process on each of the same PU sizes as those included in the search range of the CU size according to a plurality of candidate modes and generates the predicted image corresponding to the combination of the PU size and the candidate mode under the control of the block control section 12. The prediction circuit 32 may calculate the predicted pixel value of the current PU using the reference pixel value of the neighboring PU buffered in the reference image buffer 36. Here, three types of PU sizes, for example, 8×8 pixels, 16×16 pixels, and 32×32 pixels, may be included in the search range. The determination circuit 34 calculates the costs of combinations of the PU size and the candidate mode, and determines a combination of the PU size and the candidate mode in which the calculated cost is smallest. Then, the determination circuit 34 outputs the predicted image, the cost, and the mode information corresponding to the determined optimum combination to the mode setting section 27.

Referring to FIG. 13, the inter prediction section 40 includes a 32×32 inter process engine 42, a 16×16 inter process engine 44, and an 8×8 inter process engine 45. The 32×32 inter process engine 42 includes a 32×32 prediction circuit 46a and a 32×32 cost calculation circuit 47. The 32×32 prediction circuit 46a performs the inter prediction process with the PU size of 32×32 pixels, and generates the predicted image of 32×32 pixels. When the predicted images are generated, the reference pixel value of the reference frame buffered in the reference image buffer 36 may be referred to for a calculation of the predicted pixel value of the current PU. The 32×32 cost calculation circuit 47 calculates the cost using the generated predicted image and the original image. Then, the 32×32 cost calculation circuit 47 outputs the predicted image, the cost, and the mode information corresponding to the PU of 32×32 pixels to the mode setting section 27.

The 16×16 inter process engine 44 includes a 16×16 prediction circuit 46h and a 16×16 cost calculation circuit 48. The 16×16 prediction circuit 46h performs the inter prediction process with the PU size of 16×16 pixels, and generates the predicted image of 16×16 pixels. When the predicted images are generated, the reference pixel value of the reference frame buffered in the reference image buffer 36 may be referred to for a calculation of the predicted pixel value of the current PU. The 16×16 cost calculation circuit 48 calculates the cost using the generated predicted image and the original image. Then, the 16×16 cost calculation circuit 48 outputs the predicted image, the cost, and the mode information corresponding to the PU of 16×16 pixels to the mode setting section 27.

The 8×8 inter process engine 45 includes an 8×8 prediction circuit 46o and an 8×8 cost calculation circuit 49. The 8×8 prediction circuit 46o performs the inter prediction process with the PU size of 8×8 pixels, and generates the predicted image of 8×8 pixels. When the predicted images are generated, the reference pixel value of the reference frame buffered in the reference image buffer 36 may be referred to for a calculation of the predicted pixel value of the current PU. The 8×8 cost calculation circuit 49 calculates the cost using the generated predicted image and the original image. Then, the 8×8 cost calculation circuit 49 outputs the predicted image, the cost, and the mode information corresponding to the PU of 8×8 pixels to the mode setting section 27.

In order to set the block size, the mode setting section 27 compares the costs input from the determination circuit 34, the 32×32 cost calculation circuit 47, the 16×16 cost calculation circuit 48, and the 8×8 cost calculation circuit 49, and determines the block division and the prediction mode optimum for each CTB. For example, when the cost input from the 32×32 determination circuit 47 is smallest, the CU size of 32×32 pixels, the same PU size (that is, 32×32 pixels) as the CU size, and the inter prediction mode corresponding thereto may be selected. For example, when the cost input from the 16×16 cost calculation circuit 48 is smallest, the CU size of 16×16 pixels, the same PU size (that is, 16×16 pixels) as the CU size, and the inter prediction mode corresponding thereto may be selected. For example, when the cost input from the 8×8 cost calculation circuit 49 is smallest, the CU size of 8×8 pixels, the same PU size (that is, 8×8 pixels) as the CU size, and the inter prediction mode corresponding thereto may be selected. When the cost input from the determination circuit 34 is smallest, the CU size selected by the determination circuit 34, the same PU size as the CU size, and the intra prediction mode corresponding thereto may be selected.

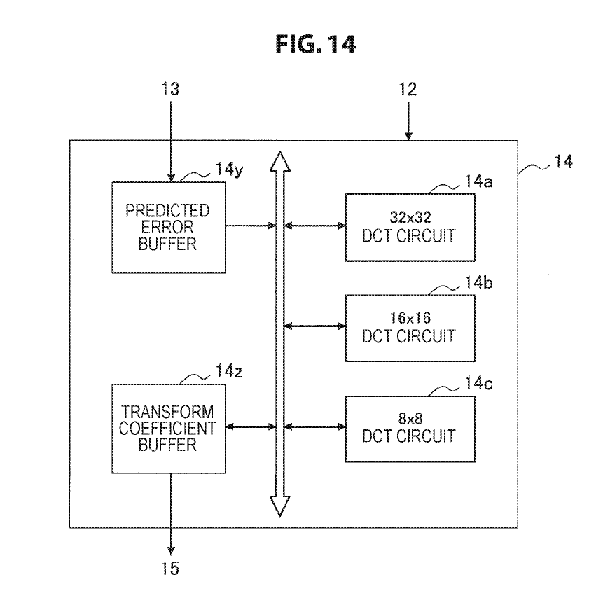

FIG. 14 is a block diagram illustrating a second example of a detailed configuration of the orthogonal transform section 14. Referring to FIG. 14, the orthogonal transform section 14 includes a 32×32 DCT circuit 14a, a 16×16 DCT circuit 14b, an 8×8 DCT circuit 14c, a predicted error buffer 14y, and a transform coefficient buffer 14z. Here, the 4×4 DCT circuit 14d illustrated in FIG. 11 is omitted from the configuration of the orthogonal transform section 14. In the present embodiment, when the CU size of 32×32 pixels is selected in the mode setting section 27, the TU size becomes 32×32 pixels, and the 32×32 DCT circuit 14a performs the orthogonal transform process on the CU. Similarly, when the CU size of 16×16 pixels is selected, the TU size becomes 16×16 pixels, and the 16×16 DCT circuit 14b performs the orthogonal transform process on the CU. When the CU size of 8×8 pixels is selected, the TU size becomes 8×8 pixels, and the 8×8 DCT circuit 14c performs the orthogonal transform process on the CU.

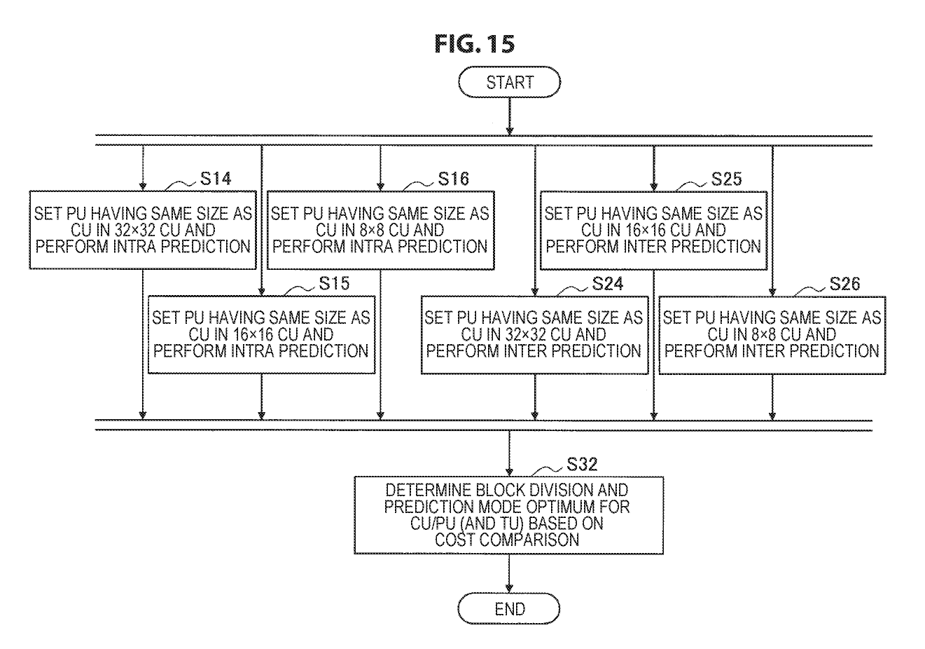

FIG. 15 is a flowchart illustrating an example of the flow of the CU/PU size search process related to FIG. 13. Referring to FIG. 15, the intra prediction section 30 sets the PU having the same size as the CU in the CU of 32×32 pixels, and performs the intra prediction on the set PU (step S14). The intra prediction section 30 sets the PU having the same size as the CU in the CU of 16×16 pixels, and performs the intra prediction on the set PU (step S15). The intra prediction section 30 sets the PU having the same size as the CU in the CU of 8×8 pixels, and performs the intra prediction on the set PU (step S16).

The 32×32 inter process engine 42 sets the PU having the same size as the CU in the CU of 32×32 pixels, and performs the inter prediction on the set PU (step S24). The 16×16 inter process engine 44 sets the PU having the same size as the CU in the CU of 16×16 pixels, and performs the inter prediction on the set PU (step S25). The 8×8 inter process engine 45 sets the PU having the same size as the CU in the CU of 8×8 pixels, and performs the inter prediction on the set PU (step S26).

Then, the mode setting section 27 determines the block division and the prediction mode optimum for the CU/PU (and the TU) based on based on the cost comparison (step S32).

In the second embodiment, the search range of the PU size is reduced to the same size as the CU. The search range of the TU size may also be reduced to the same size as the CU. Thus, since many block sizes are not searched, it is possible to reduce the processing cost, increase the processing speed, and reduce the circuit size. Further, since the CU is not divided into the PUs or the TUs which are smaller, a plurality of PUs or a plurality of TUs to be serially scanned are prevented from being set in the CU. As a result, the clock requirements for the processing circuit can be considerably relaxed, and the number of memory accesses can be further reduced.

### 2-4. Third Embodiment

In the third embodiment, the search range of the TU size is assumed not to include one or more largest candidate sizes among a plurality of selectable candidate sizes. For example, the search range of the TU size may be reduced not to include 32×32 pixels. Each of the search ranges of the CU size and the PU size may include all selectable sizes or may be reduced according to the first embodiment or the second embodiment.

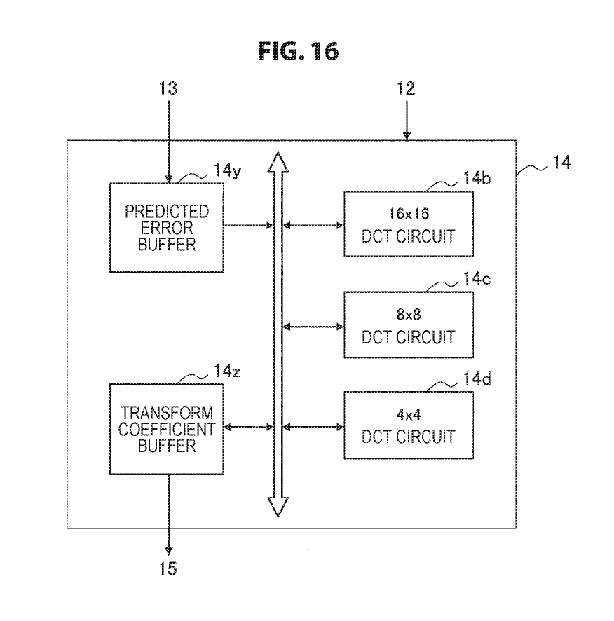

FIG. 16 is a block diagram illustrating a third example of a detailed configuration of the orthogonal transform section 14. Referring to FIG. 16, the orthogonal transform section 14 includes a 16×16 DCT circuit 14b, an 8×8 DCT circuit 14c, a 4×4 DCT circuit 14d, a predicted error buffer 14y, and a transform coefficient buffer 14z. Here, the 32×32 DCT circuit 14a illustrated in FIG. 11 is omitted from the configuration of the orthogonal transform section 14. Functions of the circuits illustrated in FIG. 16 may be the same as the functions of the same circuits described above with reference to FIG. 11. The block division optimum for the TU may be determined based on the cost comparison in the mode setting section 27 together with the decision of the CU size and the PU size.

As described above with reference to FIG. 8, the orthogonal transform process for the TU of 32×32 pixels requires many more operations than the process for the TU of 16×16 pixels. On the other hand, the coding efficiency or the image quality is not necessarily lowered even if some of the TUs of 32×32 pixels are not used. In this regard, by reducing the search range of the TU size as in the present embodiment, the coding efficiency or the image quality is slightly sacrificed, but the processing cost can be effectively reduced.

### 2-5. Modified Example

### (1) Application to Transcoding Process Between AVC and HEVC

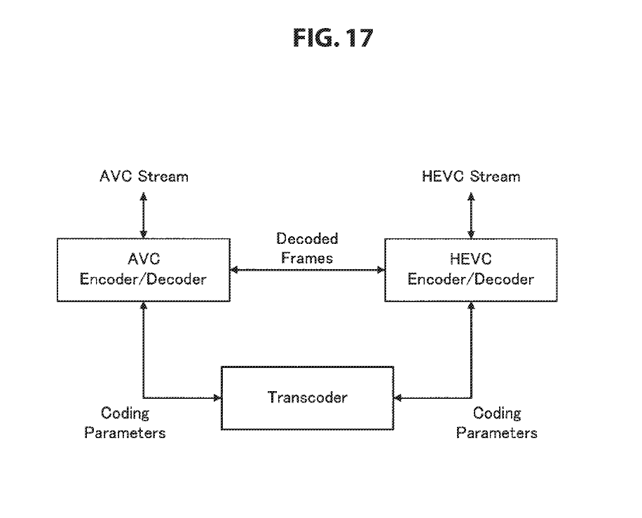

As described above, in HEVC, more types of block sizes than in AVC are selectable. However, when content encoded by HEVC is desired to be reproduced through an AVC device that supports only AVC, it is necessary to decode content through an HEVC device once and then encode content by AVC again, or transcoding from HEVC to AVC is necessary. On the other hand, when content encoded by AVC is desired to be reproduced through an HEVC device that supports only HEVC, it is necessary to decode content through an AVC device once and then encode content by HEVC again, or transcoding from AVC to HEVC is necessary. FIG. 17 illustrates an overview of the flow of a transcoding process between AVC and HEVC. A transcoder positioned between an AVC encoder/decoder and an HEVC encoder/decoder performs conversion between an encoding parameter based on AVC and an encoding parameter based on HEVC. For example, when the CU of 64×64 pixels is used in content encoded by HEVC, the macroblocks having the same size as the CU are not supported in AVC. For this reason, the transcoder resets a set of macroblocks of 16×16 pixels in the CU of 64×64 pixels, and associates the encoding parameter associated with the CU of 64×64 pixels with the individual macroblocks of 16×16 pixels again while converting the encoding parameter as necessary.

On the other hand, the HEVC encoder that encodes images according to HEVC controls the block division in a manner that sizes not supported by AVC are not included in the search range of the block size, and thus it is unnecessary to reset a block having a different size, and the process in the transcoder is reduced to simpler parameter conversion. For example, the block control section 12 may perform control in a manner that 64×64 pixels and 32×32 pixels not supported in AVC are not included in the search range of the CU size. The block control section 12 may perform control in a manner that several sizes not supported in AVC (for example, 2N×nU, 2N×nD, nL×2N, nR×2N, and the like) are not included in the search range of the PU size. Further, the block control section 12 may perform control in a manner that 32×32 pixels and 16×16 pixels not supported in the AVC scheme are not included in the search range of the TU size.

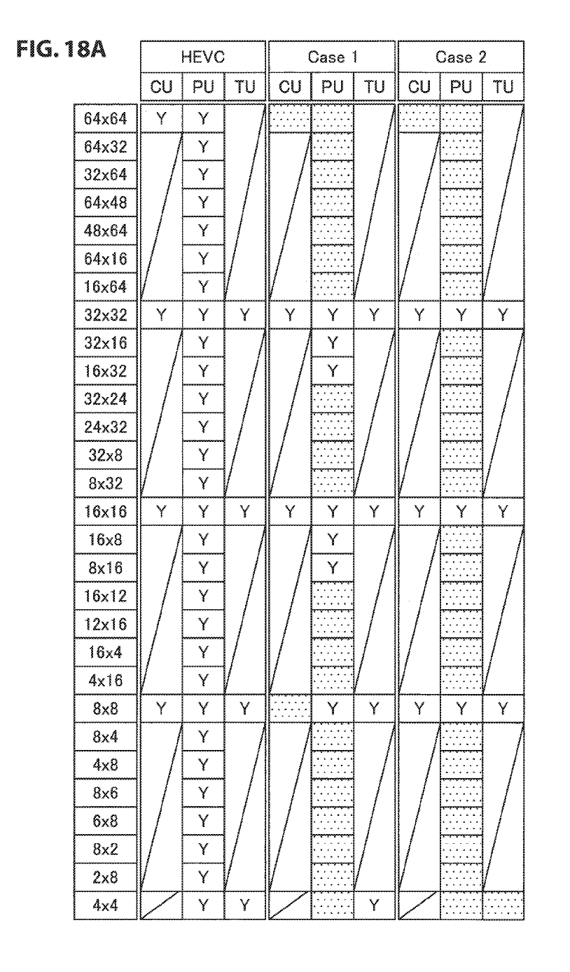

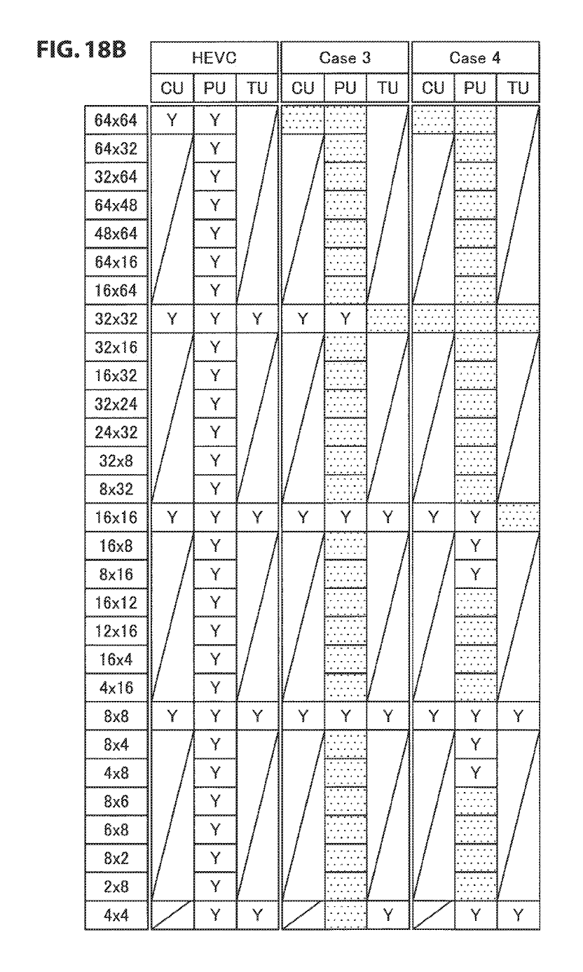

FIGS. 18A and 18B illustrate a table including a list of examples of block sizes that can be supported in the three embodiments described above and the present modified example. In FIGS. 18A and 18B, three columns on the left indicate the CU size, the PU size, and the TU size which are selectable in the HEVC specification, and sizes corresponding to fields marked “Y” are selectable. In FIG. 18A, three columns in the middle indicate the CU size, the PU size, and the TU size that can be included in the search range in the first embodiment. Here, sizes corresponding to fields marked “Y” can be included in the search range, whereas sizes corresponding to shaded fields can be excluded from the search range. In FIG. 18A, three columns on the right indicate the CU size, the PU size, and the TU size that can be included in the search range in the second embodiment. In FIG. 18B, three columns in the middle indicate the CU size, the PU size, and the TU size that can be included in the search range in the third embodiment. In FIG. 18B, three columns on the right indicate the CU size, the PU size, and the TU size that can be included in the search range in the above-described modified example related to the application to the transcoding process between AVC and HEVC. The search ranges of the block size illustrated in FIGS. 18A and 18B are merely examples, and another search range may be used. For example, in the second embodiment, the CU, the PU, and the TU of 64×64 pixels may be included in the search range.

In the above-described modified example related to the application to the transcoding process between AVC and HEVC, the search range of the CU size may include 16×16 pixels and 8×8 pixels, the search range of the PU size may include 16×16 pixels, 16×8 pixels, 8×16 pixels, 8×8 pixels, 8×4 pixels, 4×8 pixels, and 4×4 pixels, and the search range of the TU size may include 8×8 pixels and 4×4 pixels.

### (2) Control of Adaptive Search Range

The block control section 12 may set one of a plurality of operation modes in the image encoding device 10 and control the search range of the block size according to the set operation mode. For example, the block control section 12 may set the search range of one or more of the CU, the PU, and the TU to a first range in a first operation mode and set the search range to a second range narrower than the first range in a second operation mode different from the first operation mode. As an example, the first operation mode is a normal mode, and the second operation mode is a low load mode. As another example, the first operation mode is a high image quality mode, and the second operation mode is a normal mode. As another example, the first operation mode is a normal mode, and the second operation mode is a transcoding mode. The first range and the second range may correspond to one of the search ranges illustrated in FIGS. 18A and 18B or may be different ranges from the search ranges. For example, the block control section 12 may control switching between the first operation mode and the second operation mode according to performance related to at least one of the encoding process and the prediction process. Here, the performance may be performance specific to a device (which is decided according to the above embodiments, for example) or may be temporal performance (a processor use rate, a memory use rate, or the like) that varies according to execution states of other processes.

### 3. EXEMPLARY HARDWARE CONFIGURATION

The embodiments may be implemented using software, hardware, or a combination of software and hardware. For example, when the image encoding device 10 uses software, a program constituting software is stored in a storage medium (a non-transitory medium) in advance installed inside or outside an apparatus. For example, each program is read in a random access memory (RAM) and executed by a processor such as a central processing unit (CPU).

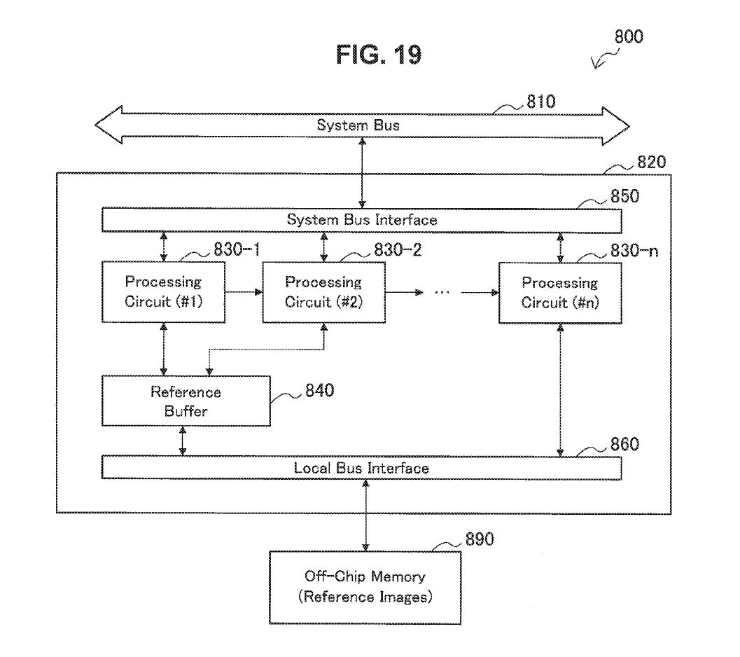

FIG. 19 is a block diagram illustrating an example of a hardware configuration of an encoder to which the above embodiments can be applied. Referring to FIG. 19, an encoder 800 includes a system bus 810, an image processing chip 820, and an off-chip memory 890. The image processing chip 820 includes n (n is 1 or more) processing circuits 830-1, 830-2, . . . , and 830-n, a reference buffer 840, a system bus interface 850, and a local bus interface 860.

The system bus 810 provides a communication path between the image processing chip 820 and an external module (for example, a central control function, an application function, a communication interface, a user interface, or the like). The processing circuits 830-1, 830-2, . . . , and 830-n are connected with the system bus 810 through the system bus interface 850 and are connected with the off-chip memory 890 through the local bus interface 860. The processing circuit 830-1, 830-2, . . . , and 830-n can access the reference buffer 840 that may correspond to an on-chip memory (for example, a SRAM). For example, the off-chip memory 890 may be a frame memory that stores image data to be processed by the image processing chip 820.

As an example, the processing circuit 830-1 may correspond to the intra prediction section 30, the processing circuit 830-2 may correspond to the inter prediction section 40, another processing circuit may correspond to the orthogonal transform section 14, another processing circuit may correspond to the lossless encoding section 16, and another processing circuit may correspond to the mode setting section 27. The processing circuits may be formed on separate chips rather than the same image processing chip 820. By reducing the search range of the block size for the encoding process, the prediction process or the orthogonal transform process through the above-described techniques, the processing cost and the power consumption in the image processing chip 820 are reduced. Further, it is possible to reduce the buffer size of the reference buffer 840 and reduce the number of accesses to the reference buffer 840 from the processing circuits. A band required for data input and output between the image processing chip 820 and the off-chip memory 890 can be reduced.

### 4. APPLICATION EXAMPLES

### 4-1. Applications to Various Products

The above embodiments can be applied to various electronic devices such as a transmitting device that transmits an encoded stream of a video using a satellite circuit, a cable television circuit, the Internet, a cellular communication network, or the like or a recording device that records an encoded stream of a video in a medium such as an optical disc, a magnetic disk, or a flash memory. Three application examples will be described below.

### (1) First Application Example

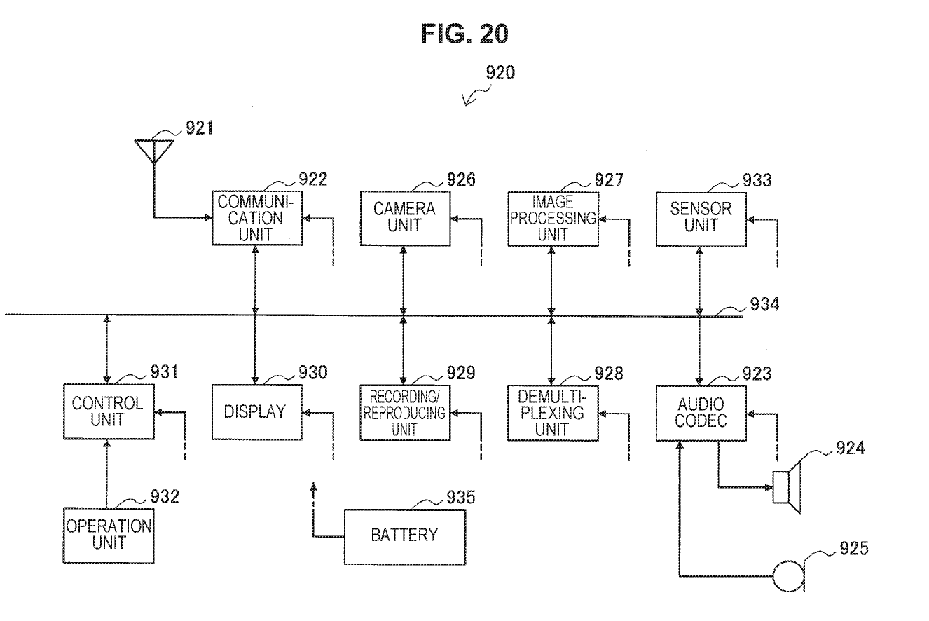

FIG. 20 is a diagram illustrating an example of a schematic configuration of a mobile telephone applying the aforementioned embodiment. A mobile telephone 920 includes an antenna 921, a communication unit 922, an audio codec 923, a speaker 924, a microphone 925, a camera unit 926, an image processing unit 927, a demultiplexing unit 928, a recording/reproducing unit 929, a display 930, a control unit 931, an operation unit 932, a sensor unit 933, a bus 934, and a battery 935.

The antenna 921 is connected to the communication unit 922. The speaker 924 and the microphone 925 are connected to the audio codec 923. The operation unit 932 is connected to the control unit 931. The bus 934 mutually connects the communication unit 922, the audio codec 923, the camera unit 926, the image processing unit 927, the demultiplexing unit 928, the recording/reproducing unit 929, the display 930, the control unit 931, and the sensor unit 933.

The mobile telephone 920 performs an operation such as transmitting/receiving an audio signal, transmitting/receiving an electronic mail or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of the recording/reproducing unit 929.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the recording/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 subsequently transmits the generated transmission signal to the base station (not shown) through the antenna 921. Moreover, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then supplies the generated audio signal to the speaker 924 to output the audio.

The sensor unit 933 includes a group of sensors such as an acceleration sensor and a gyro sensor, and outputs an index indicating motion of the mobile telephone 920. The battery 935 supplies electric power to the communication unit 922, the audio codec 923, the camera unit 926, the image processing unit 927, the demultiplexing unit 928, the recording/reproducing unit 929, the display 930, the control unit 931, and the sensor unit 933 through a power supply line (not illustrated).

In the mobile telephone 920 having the above configuration, the image processing section 927 has the function of the image encoding device 10 according to the above embodiments. Thus, in the mobile telephone 920, the search range of the block size can be reduced, and the resources of the mobile telephone 920 can be efficiently used.

### (2) Second Application Example

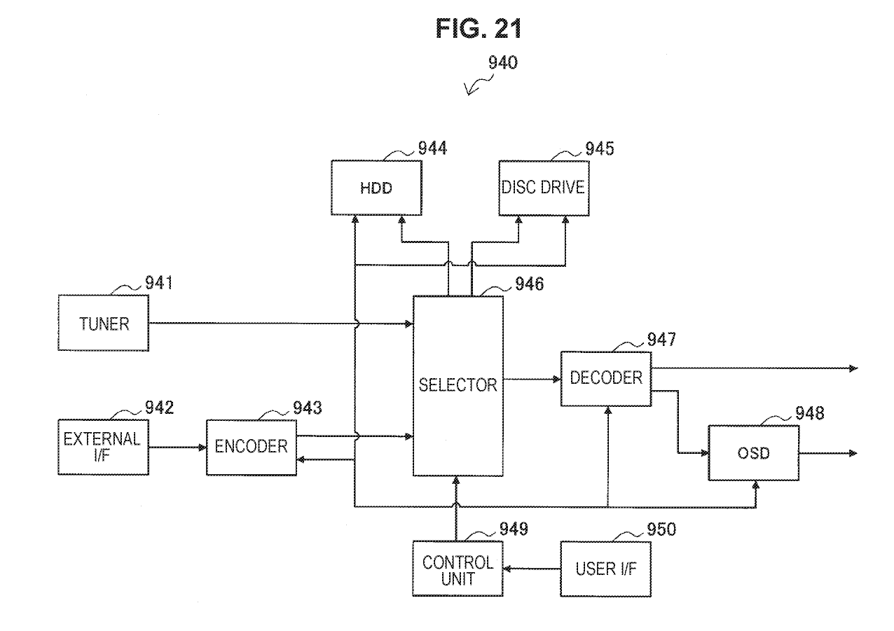

FIG. 21 is a diagram illustrating an example of a schematic configuration of a recording/reproducing device applying the aforementioned embodiment. A recording/reproducing device 940 encodes audio data and video data of a broadcast program received and records the data into a recording medium, for example. The recording/reproducing device 940 may also encode audio data and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording/reproducing device 940.

The encoder 943 encodes the video data and the audio data when the video data and the audio data input from the external interface 942 are not encoded. The encoder 943 thereafter outputs an encoded bit stream to the selector 946.

The HDD 944 records, into an internal hard disk, the encoded bit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded bit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a CPU and a memory such as a RAM and a ROM. The memory stores a program executed by the CPU as well as program data. The program stored in the memory is read by the CPU at the start-up of the recording/reproducing device 940 and executed, for example. By executing the program, the CPU controls the operation of the recording/reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

In the recording/reproducing device 940 having the above configuration, the encoder 943 has the function of the image encoding device 10 according to the above embodiments. Thus, in the recording/reproducing device 940, the search range of the block size can be reduced, and the resources of the recording/reproducing device 940 can be efficiently used.

### (3) Third Application Example

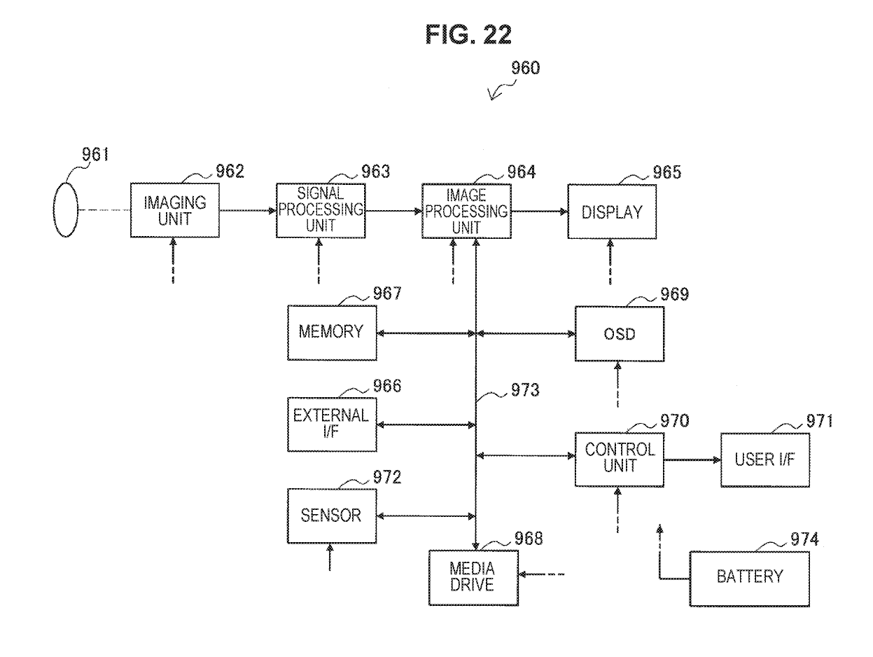

FIG. 22 shows an example of a schematic configuration of an image capturing device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, a sensor 972, a bus 973, and a battery 974.

The optical block 961 is connected to the imaging unit 962. The imaging unit 962 is connected to the signal processing unit 963. The display 965 is connected to the image processing unit 964. The user interface 971 is connected to the control unit 970. The bus 973 mutually connects the image processing unit 964, the external interface 966, the memory 967, the media drive 968, the OSD 969, the control unit 970, and the sensor 972.

The optical block 961 includes a focus lens and a diaphragm mechanism. The optical block 961 forms an optical image of the object on an imaging surface of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging surface into an image signal as an electric signal. Subsequently, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964.

The external interface 966 is configured as a USB input/output terminal, for example. The external interface 966 connects the imaging device 960 with a printer when printing an image, for example. Moreover, a drive is connected to the external interface 966 as needed. A removable medium such as a magnetic disk or an optical disk is mounted to the drive, for example, so that a program read from the removable medium can be installed to the imaging device 960. The external interface 966 may also be configured as a network interface that is connected to a network such as a LAN or the Internet. That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mounted to the media drive 968 so that a non-transportable storage unit such as a built-in hard disk drive or an SSD (Solid State Drive) is configured, for example.

The control unit 970 includes a processor such as a CPU and a memory such as a RAM and a ROM. The memory stores a program executed by the CPU as well as program data. The program stored in the memory is read by the CPU at the start-up of the imaging device 960 and then executed. By executing the program, the CPU controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The sensor 972 includes a group of sensors such as an acceleration sensor and a gyro sensor, and outputs an index indicating motion of the imaging device 960. The battery 974 supplies electric power to the imaging unit 962, the signal processing unit 963, the image processing unit 964, the display 965, the media drive 968, the OSD 969, the control unit 970, and the sensor 972 through a power supply line (not illustrated).

In the imaging device 960 having the above configuration, the image processing unit 964 has the function of the image encoding device 10 according to the above embodiments. Thus, in the imaging device 960, the search range of the block size can be reduced, and the resources of the imaging device 960 can be efficiently used.

### 4-2. Various Implementation Levels

The technology according to the present disclosure may be implemented at various implementation levels such as a processor including a system large scale integration (LSI) or the like, a module using a plurality of processors, a unit using a plurality of modules, and a set in which other functions are further added to a unit.

### (1) Video Set

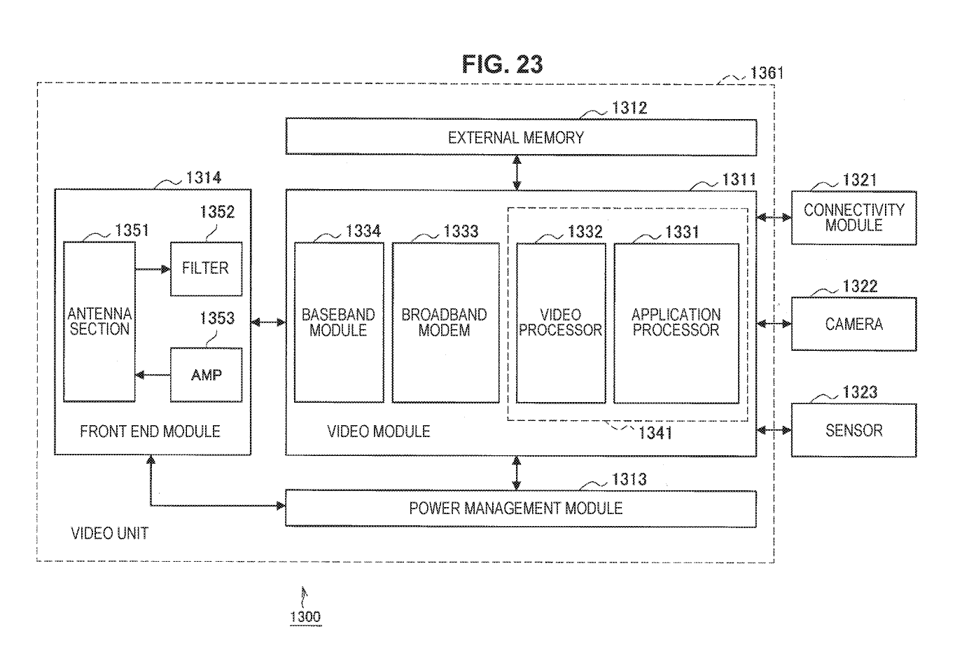

An example in which the technology according to the present disclosure is implemented as a set will be described with reference to FIG. 23. FIG. 23 is a block diagram illustrating an example of a schematic configuration of a video set.

In recent years, functions of electronic devices have become diverse. In development and manufacturing of electronic devices, development and manufacturing are performed for each individual function, and then a plurality of functions are integrated. Thus, there are companies that manufacture or sell only some electronic devices. The companies provide components having a single function or a plurality of relevant functions or provide sets having an integrated function group. A video set 1300 illustrated in FIG. 23 is a set that includes a component for encoding and decoding (or one of encoding and decoding) of an image and a component having another function relevant to the functions in an integrated manner.

Referring to FIG. 23, the video set 1300 includes a module group such as a video module 1311, an external memory 1312, a power management module 1313, and a front end module 1314 and a device group having relevant functions such as a connectivity module 1321, a camera 1322, and a sensor 1323.

The module is a component formed by integrating parts for several relevant functions. The module may have any physical configuration. As an example, the module may be formed by arranging a plurality of processors having the same or different functions, electronic circuit elements such as a resistor and a capacitor, and other devices in an integrated manner on a circuit board. Another module may be formed by combining a module with another module, a processor, or the like.

In the example of FIG. 23, parts for functions related to image processing are integrated in the video module 1311. The video module 1311 includes an application processor 1331, a video processor 1332, a broadband modem 1333, and a baseband module 1334.

The processor may be, for example, a system on a chip (SOC) or a system LSI. The SoC or the system LSI may include hardware for implementing a predetermined logic. The SoC or the system LSI may include a CPU and a non-transitory tangible medium that stores a program for causing the CPU to execute a predetermined function. The program may be, for example, stored in a ROM and read in a RAM at the time of execution and executed by the CPU.

The application processor 1331 is a processor that executes an application related to image processing. The application executed in the application processor 1331 may perform, for example, control of the video processor 1332 and other components in addition to some sort of operations for image processing. The video processor 1332 is a processor having a function related to encoding and decoding of an image. The application processor 1331 and the video processor 1332 may be integrated into one processor (see a dotted line 1341 in FIG. 39).

The broadband modem 1333 is a module that performs a process related to communication via a network such as the Internet or a public switched telephone network (PSTN). For example, the broadband modem 1333 performs digital modulation of converting a digital signal including transmission data into an analogue signal and digital demodulation of converting an analogue signal including reception data into a digital signal. The transmission data and the reception data processed by the broadband modem 1333 may include arbitrary information such as image data, an encoded stream of image data, application data, an application program, and setting data.

The baseband module 1334 is a module that performs a baseband process for a radio frequency (RF) signal transmitted and received through the front end module 1314. For example, the baseband module 1334 modulates a transmission baseband signal including transmission data, performs a frequency transform of the transmission baseband signal into an RF signal, and outputs the RF signal to the front end module 1314. The baseband module 1334 performs a frequency transform on an RF signal input from the front end module 1314, performs demodulations, and generates a reception baseband signal including reception data.

The external memory 1312 is a memory device that is installed outside the video module 1311 and accessible from the video module 1311. When large-scale data such as video data including a plurality of frames is stored in the external memory 1312, the external memory 1312 may include a large-capacity semiconductor memory that is relatively cheap such as a dynamic random access memory (DRAM).

The power management module 1313 is a module that controls power supply to the video module 1311 and the front end module 1314.

The front end module 1314 is a module that is connected to the baseband module 1334 and provides a front end function. In the example of FIG. 23, the front end module 1314 includes an antenna section 1351, a filter 1352, and an amplification section 1353. The antenna section 1351 includes one or more antenna elements that transmit or receive a radio signal and a relevant component such as an antenna switch. The antenna section 1351 transmits the RF signal amplified by the amplification section 1353 as the radio signal. The antenna section 1351 outputs the RF signal received as the radio signal to the filter 1352, and causes the filter 1352 to filter the RF signal.

The connectivity module 1321 is a module having a function related to an external connection of the video set 1300. The connectivity module 1321 may support an arbitrary external connection protocol. For example, the connectivity module 1321 may include a sub module that supports a wireless connection protocol such as Bluetooth (a registered trademark), IEEE 802.11 (for example, Wi-Fi (a registered trademark)), Near Field Communication (NFC), or InfraRed Data Association (IrDA) and a corresponding antenna. The connectivity module 1321 may include a sub module that supports a wired connection protocol such as Universal Serial Bus (USB) or High-Definition Multimedia Interface (HDMI) and a corresponding connection terminal.

The connectivity module 1321 may include a drive that writes or reads data in or from a storage device such as a storage medium such as a magnetic disk, an optical disc, a magneto optical disc, or a semiconductor memory, a Solid State Drive (SSD), or a Network Attached Storage (NAS). The connectivity module 1321 may include the storage medium or the storage device. The connectivity module 1321 may provide connectivity with a display displaying an image or a speaker outputting a sound.

The camera 1322 is a module that acquires a photographed image by photographing a subject. A series of photographed images acquired by the camera 1322 constitutes video data. For example, the video data generated by the camera 1322 may be encoded by the video processor 1332 as necessary and stored in the external memory 1312 or a storage medium connected to the connectivity module 1321.

The sensor 1323 is a module that may include one or more of, for example, a GPS sensor, a sound sensor, an ultrasonic sensor, an optical sensor, an illuminance sensor, an infrared sensor, an angular velocity sensor, an angular acceleration sensor, a velocity sensor, an acceleration sensor, a gyro sensor, a geomagnetic sensor, a shock sensor, and a temperature sensor. For example, sensor data generated by the sensor 1323 may be used for execution of an application by the application processor 1331.

In the video set 1300 having the above configuration, the technology according to the present disclosure may be used, for example, in the video processor 1332. In this case, the video set 1300 is a set to which the technology according to the present disclosure is applied.

The video set 1300 may be implemented as various kinds of devices processing image data. For example, the video set 1300 may correspond to the television device 900, the mobile telephone 920, the recording/reproducing device 940, or the imaging device 960 described above with reference to FIGS. 20 to 23.

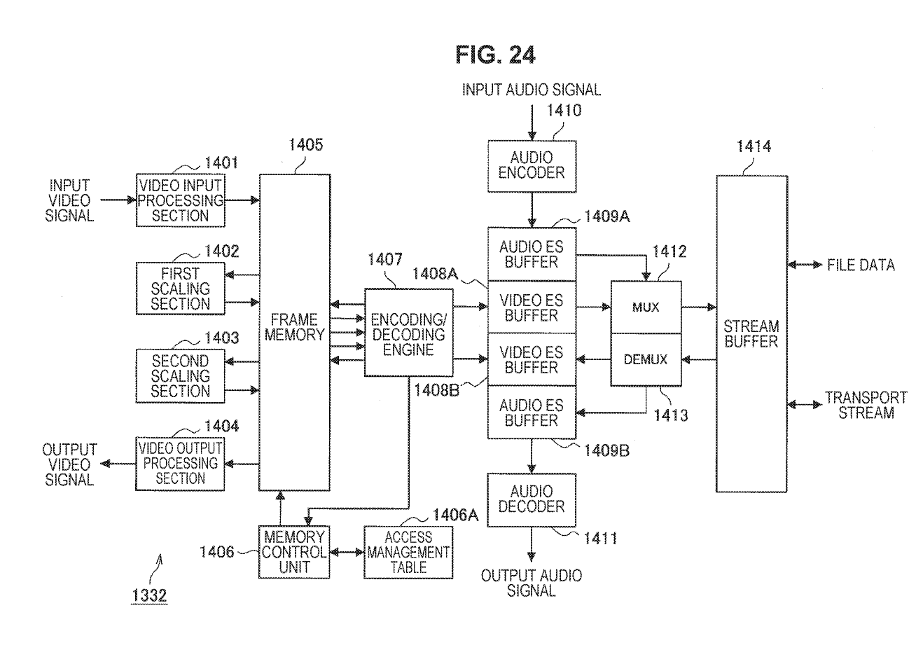

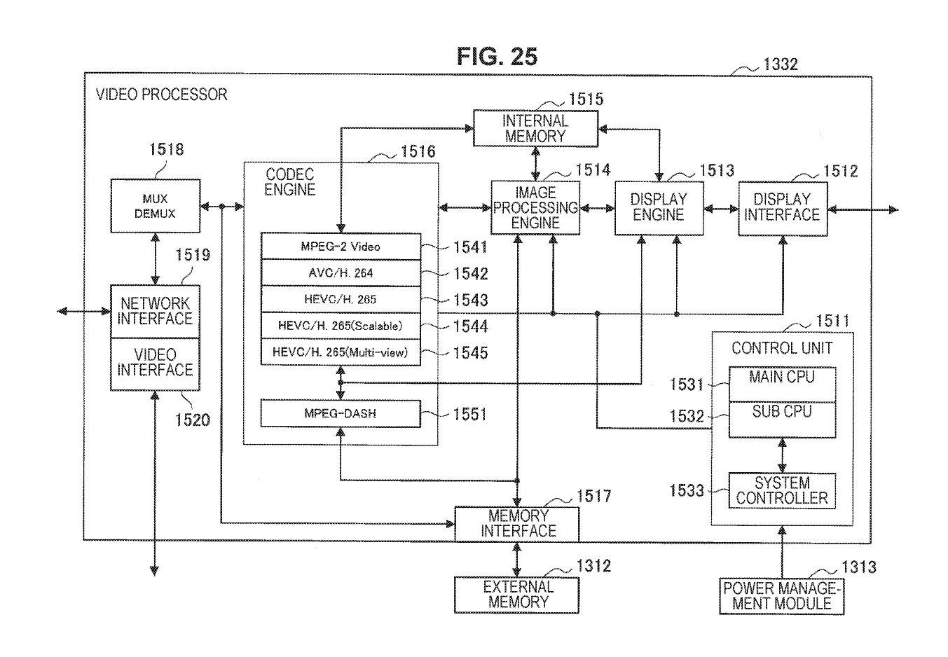

The video set 1300 may correspond to a terminal device such as the personal computer 1004, the AV device 1005, the tablet device 1006, or the mobile telephone 1007 in the data transmission system 1000 described above with reference to FIG. 24, the broadcasting station 1101 or the terminal device 1102 in the data transmission system 1100 described above with reference to FIG. 25, or the imaging device 1201 or the stream storage device 1202 in the imaging system 1200 described above with reference to FIG. 26.

### (2) Video Processor

FIG. 24 is a block diagram illustrating an example of a schematic configuration of the video processor 1332. The video processor 1332 has a function of encoding an input video signal and an input audio signal and generating video data and audio data and a function of decoding encoded video data and audio data and generating an output video signal and an output audio signal.

Referring to FIG. 24, the video processor 1332 includes a video input processing section 1401, a first scaling section 1402, a second scaling section 1403, a video output processing section 1404, a frame memory 1405, a memory control unit 1406, an encoding/decoding engine 1407, video elementary stream (ES) buffers 1408A and 1408B, audio ES buffers 1409A and 1409B, an audio encoder 1410, an audio decoder 1411, a multiplexer (MUX) 1412, a demultiplexer (DEMUX) 1413, and the stream buffer 1414.

The video input processing section 1401 converts, for example, the video signal input from the connectivity module 1321 into digital image data. The first scaling section 1402 performs format conversion and scaling (enlargement/reduction) on the image data input from the video input processing section 1401. The second scaling section 1403 performs format conversion and scaling (enlargement/reduction) on the image data to be output to the video output processing section 1404. The format conversion in the first scaling section 1402 and the second scaling section 1403 may be, for example, conversion between a 4:2:2/Y-Cb-Cr scheme and a 4:2:0/Y-Cb-Cr scheme or the like. The video output processing section 1404 converts the digital image data to the output video signal, and outputs the output video signal, for example, to the connectivity module 1321.

The frame memory 1405 is a memory device that stores the image data shared by the video input processing section 1401, the first scaling section 1402, the second scaling section 1403, the video output processing section 1404, and the encoding/decoding engine 1407. For example, the frame memory 1405 may be implemented using a semiconductor memory such as a DRAM.

The memory control unit 1406 controls access to the frame memory 1405 according to an access schedule for the frame memory 1405 which is stored in an access management table 1406A based on a synchronous signal input from the encoding/decoding engine 1407. The access management table 1406A is updated by the memory control unit 1406 depending on the process performed in the encoding/decoding engine 1407, the first scaling section 1402, the second scaling section 1403, and the like.

The encoding/decoding engine 1407 performs an encoding process of encoding image data and generating an encoded video stream and a decoding process of decoding image data from the encoded video stream. For example, the encoding/decoding engine 1407 encodes image data read from the frame memory 1405, and sequentially writes the encoded video stream in the video ES buffer 1408A. For example, the image data that is sequentially read from the video ES buffer 1408B to the encoded video stream and decoded is stored in the frame memory 1405. The encoding/decoding engine 1407 may use the frame memory 1405 as a work area in these processes. The encoding/decoding engine 1407 outputs the synchronous signal to the memory control unit 1406, for example, at a timing at which processing of each LCU starts.

The video ES buffer 1408A buffers the encoded video stream generated by the encoding/decoding engine 1407. The encoded video stream buffered in the video ES buffer 1408A is output to the multiplexer 1412. The video ES buffer 1408B buffers the encoded video stream input from the demultiplexer 1413. The encoded video stream buffered in the video ES buffer 1408B is output to the encoding/decoding engine 1407.

The audio ES buffer 1409A buffers the encoded audio stream generated by the audio encoder 1410. The encoded audio stream buffered in the audio ES buffer 1409A is output to the multiplexer 1412. The audio ES buffer 1409B buffers the encoded audio stream input from the demultiplexer 1413. The encoded audio stream buffered in the audio ES buffer 1409B is output to the audio decoder 1411.

For example, the audio encoder 1410 performs digital conversion on the input audio signal input from the connectivity module 1321, and encodes the input audio signal according to an audio coding scheme such as an MPEG audio scheme or an Audio Code number 3 (AC3) scheme. The audio encoder 1410 sequentially writes the encoded audio stream in the audio ES buffer 1409A. The audio decoder 1411 decodes audio data from the encoded audio stream input from the audio ES buffer 1409B, and converts the audio data into an analogue signal. For example, the audio decoder 1411 outputs an audio signal to the connectivity module 1321 as a reproduced analogue audio signal.

The multiplexer 1412 multiplexes the encoded video stream and the encoded audio stream, and generates a multiplexed bitstream. The multiplexed bitstream may have any format. The multiplexer 1412 may add predetermined header information to the bitstream. The multiplexer 1412 may convert the format of the stream. For example, the multiplexer 1412 may generate a transport stream (a bitstream of a transport format) in which the encoded video stream and the encoded audio stream are multiplexed. The multiplexer 1412 may generate file data (data of a recording format) in which the encoded video stream and the encoded audio stream are multiplexed.

The demultiplexer 1413 demultiplexes the encoded video stream and the encoded audio stream from the multiplexed bitstream through a technique opposite to the multiplexing by the multiplexer 1412. In other words, the demultiplexer 1413 extracts (or separates) the video stream and the audio stream from the bitstream read from the stream buffer 1414. The demultiplexer 1413 may perform conversion (inverse conversion) of the format of the stream. For example, the demultiplexer 1413 may acquire the transport stream that can be input from the connectivity module 1321 or the broadband modem 1333 through the stream buffer 1414 and convert the transport stream into the video stream and the audio stream. The demultiplexer 1413 may acquire the file data read from the storage medium through the connectivity module 1321 through the stream buffer 1414 and convert the file data into the video stream and the audio stream.

The stream buffer 1414 buffers the bitstream. For example, the stream buffer 1414 buffers the transport stream input from the multiplexer 1412 and outputs the transport stream, for example, to the connectivity module 1321 or the broadband modem 1333 at a predetermined timing or according to a request from the outside. For example, the stream buffer 1414 buffers the file data input from the multiplexer 1412 and outputs the file data, for example, to the connectivity module 1321 at a predetermined timing or according to a request from the outside for recording. Further, the stream buffer 1414 buffers the transport stream acquired, for example, through the connectivity module 1321 or the broadband modem 1333 and outputs the transport stream to the demultiplexer 1413 at a predetermined timing or according to a request from the outside. The stream buffer 1414 buffers the file data read from the storage medium, for example, through the connectivity module 1321 and outputs the file data to the demultiplexer 1413 at a predetermined timing or according to a request from the outside.

In the video processor 1332 having the above configuration, the technology according to the present disclosure may be used, for example, in the encoding/decoding engine 1407. In this case, the video processor 1332 is a chip or a module to which the technology according to the present disclosure is applied.

FIG. 25 is a block diagram illustrating another example of a schematic configuration of the video processor 1332. In the example of FIG. 25, the video processor 1332 has a function of encoding and decoding the video data according to a predetermined scheme.

Referring to FIG. 25, the video processor 1332 includes a control unit 1511, a display interface 1512, a display engine 1513, an image processing engine 1514, an internal memory 1515, a codec engine 1516, a memory interface 1517, a multiplexer/demultiplexer (MUX DMUX) 1518, a network interface 1519, and a video interface 1520.

The control unit 1511 controls operations of various processing sections in the video processor 1332 such as the display interface 1512, the display engine 1513, the image processing engine 1514, and the codec engine 1516. For example, the control unit 1511 includes a main CPU 1531, a sub CPU 1532, and a system controller 1533. The main CPU 1531 executes a program for controlling the operations of the processing sections in the video processor 1332. The main CPU 1531 supplies a control signal generated by execution of the program to the respective processing sections. The sub CPU 1532 serves as an auxiliary role of the main CPU 1531. For example, the sub CPU 1532 executes a child process and a sub routine of the program executed by the main CPU 1531. The system controller 1533 manages execution of the program by the main CPU 1531 and the sub CPU 1532.

The display interface 1512 outputs the image data, for example, to the connectivity module 1321 under control of the control unit 1511. For example, the display interface 1512 outputs an analogue image signal converted from the digital image data or digital image data to a display connected to the connectivity module 1321. The display engine 1513 performs format conversion, size conversion, and color gamut conversion on the image data under control of the control unit 1511 so that an attribute of the image data complies with a specification of the display serving as an output destination. The image processing engine 1514 performs image processing that may include a filtering process for improving the image quality or the like on the image data under control of the control unit 1511.

The internal memory 1515 is a memory device that is shared by the display engine 1513, the image processing engine 1514, and the codec engine 1516 and installed in the video processor 1332. For example, the internal memory 1515 is used when the image data is input or output among the display engine 1513, the image processing engine 1514, and the codec engine 1516. The internal memory 1515 may be any type of memory device. For example, the internal memory 1515 may have a relatively small memory size for storing image data of block units and a relevant parameter. The internal memory 1515 may be a memory that has a smaller capacity (for example, than the external memory 1312) but a high response speed such as a static random access memory (SRAM).

The codec engine 1516 performs the encoding process for encoding the image data and generating the encoded video stream and the decoding process of decoding the image data from the encoded video stream. The image coding scheme supported by the codec engine 1516 may be an arbitrary one or more schemes. In the example of FIG. 25, the codec engine 1516 includes an MPEG-2 video block 1541, an AVC/H.264 block 1542, a HEVC/H.265 block 1543, a HEVC/H.265 (scalable) block 1544, a HEVC/H.265 (multi-view) block 1545, and an MPEG-DASH block 1551. The functional blocks encode and decode the image data according to corresponding image coding schemes.

The MPEG-DASH block 1551 is a functional block capable of transmitting the image data according to an MPEG-DASH scheme. The MPEG-DASH block 1551 performs control of transmission of a stream complying with the standard specification and transmission of the generated stream. The encoding and decoding of the transmitted image data may be performed by any other functional block included in the codec engine 1516.

The memory interface 1517 is an interface for connecting the video processor 1332 with the external memory 1312. The data generated by the image processing engine 1514 or the codec engine 1516 is output to the external memory 1312 through the memory interface 1517. The data input from the external memory 1312 is supplied to the image processing engine 1514 or the codec engine 1516 through the memory interface 1517.

The multiplexer/demultiplexer 1518 performs multiplexing and demultiplexing of the encoded video stream and a relevant bitstream. At the time of multiplexing, the multiplexer/demultiplexer 1518 may add predetermined header information to the multiplexed stream. At the time of demultiplexing, the multiplexer/demultiplexer 1518 may add predetermined header information to separated individual streams. In other words, the multiplexer/demultiplexer 1518 may perform format conversion together with multiplexing or demultiplexing. For example, the multiplexer/demultiplexer 1518 may support conversion and inverse conversion between a plurality of bitstreams and a transport stream serving as a multiplexed stream having a transport format and conversion and inverse conversion between a plurality of bitstreams and file data having a recording format.

The network interface 1519 is an interface for connecting, for example, the video processor 1332 with the broadband modem 1333 or the connectivity module 1321. The video interface 1520 is an interface for connecting, for example, the video processor 1332 with the connectivity module 1321 or the camera 1322.

In the video processor 1332 having the above configuration, the technology according to the present disclosure may be used, for example, in the codec engine 1516. In this case, the video processor 1332 may be a chip or a module to which the technology according to the present disclosure is applied.

The configuration of the video processor 1332 is not limited to the above two examples. For example, the video processor 1332 may be implemented as one semiconductor chip or may be implemented as a plurality of semiconductor chips. The video processor 1332 may be implemented by a 3D integrated LSI or a combination of a plurality of LSIs formed by integrating a plurality of semiconductors.

### 5. CONCLUSION

The exemplary embodiments of the technology according to the present disclosure have been described above in detail with reference to FIGS. 1 to 25. According to the above embodiments, in the apparatus that encodes images according to an image coding scheme in which the CUs are formed by recursively dividing an image to be encoded, and one or more PUs are set in the CU, the search range of at least one block size of the CU and the PU is reduced so that one or more smallest candidate sizes among a plurality of candidate sizes selectable in the specification of the image coding scheme are not included. As a result, there is room between clocks of the processing circuit, and the number of memory accesses to a memory from processing circuits can be reduced. The search range of the CU size may be reduced so that one or more largest candidate sizes among a plurality of selectable candidate sizes are not included. Thus, the maximum size of the reference block to be held in the on-chip memory can be reduced. As a result of reduction, the performance requirements for the encoder are more relaxed than in the technique of searching all block sizes comprehensively, and thus the implementation cost of the encoder can be reduced.

The technology according to the present disclosure may be applied to the scalable video coding technique. The scalable video coding technique of HEVC is also referred to as SHVC. For example, the above embodiments can be applied to individual layers (a base layer and an enhancement layer) included in an encoded multi-layer stream. The information related to the block division may be generated and encoded in units of layers or may be re-used between layers. The technology according to the present disclosure may be applied to a multi-view encoding technique. For example, the above embodiments can be applied to individual views (a base view and an enhancement view) included in a multi-view encoded stream. The information related to the block division may be generated and encoded in units of views or may be re-used between views.

The terms “CU,” “PU,” and “TU” described in the present specification refer to logical units including a syntax associated with an individual block in HEVC. When only individual blocks which are parts of an image are focused on, the blocks may be referred to with the terms “coding block (CB),” “prediction block (PB),” and “transform block (TB).” A CB is formed by hierarchically dividing a coding tree block (CTB) in a quad-tree shape. The one entire quad-tree corresponds to the CTB and a logical unit corresponding to the CTB is referred to as a coding tree unit (CTU).

Mainly described herein is the example where the various pieces of information such as the information related to block division are multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the information may be transmitted on a different transmission path from the image (or the bit stream). The information may also be recorded in a different recording medium (or a different recording area in the same recording medium) from the image (or the bit stream). Furthermore, the information and the image (or the bit stream) may be associated with each other by an arbitrary unit such as a plurality of frames, one frame, or a portion within a frame.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

In addition, the effects described in the present specification are merely illustrative and demonstrative, and not limitative. In other words, the technology according to the present disclosure can exhibit other effects that are evident to those skilled in the art along with or instead of the effects based on the present specification.

Additionally, the present technology may also be configured as below.

(1)

An image processing apparatus, including:

a setting section configured to set a size of at least one of a coding unit formed by recursively dividing an image to be encoded and a prediction unit to be set in the coding unit according to a search range of the size of the at least one of the coding unit and the prediction unit, one or more smallest candidate sizes among all candidate sizes being excluded from the search range; and

an encoding section configured to encode the image according to the size of the coding unit or the prediction unit set by the setting section.

(2)

The image processing apparatus according to (1),

wherein the setting section sets the size of the prediction unit according to the search range from which a candidate size different from the size of the coding unit is excluded.

(3)

The image processing apparatus according to (1) or (2),

wherein the setting section sets a size of a transform unit serving as a unit in which an orthogonal transform process is performed according to a search range of the size of the transform unit, a candidate size different from the size of the coding unit being excluded from the search range.

(4)

The image processing apparatus according to any one of (1) to (3),

wherein the setting section sets the size of the coding unit according to the search range from which a candidate size of 8×8 pixels is excluded.

(5)

The image processing apparatus according to any one of (1) to (4),

wherein the setting section sets the size of the prediction unit with which intra prediction is performed according to the search range from which a candidate size of 4×4 pixels is excluded.

(6)

The image processing apparatus according to any one of (1) to (5),

wherein the setting section sets the size of the at least one of the coding unit and the prediction unit according to the search range from which one or more largest candidate sizes among all candidates sizes are excluded.

(7)

The image processing apparatus according to (6),

wherein the setting section sets the size of the coding unit according to the search range from which a candidate size of 64×64 pixels is excluded.

(8)

The image processing apparatus according to any one of (1) to (7),

wherein the setting section sets a size of a transform unit serving as a unit in which an orthogonal transform process is performed according to a search range of the size of the transform unit, one or more largest candidate sizes among all candidate sizes being excluded from the search range.

(9)

The image processing apparatus according to (8),

wherein the setting section sets the size of the transform unit according to the search range from which a candidate size of 32×32 pixels is excluded.

(10)

The image processing apparatus according to any one of (1) to (9),

wherein the setting section sets the size of the coding unit according to the search range from which a candidate size not supported in an Advanced Video Coding (AVC) standard is excluded.

(11)

The image processing apparatus according to (10),

wherein the setting section sets the size of the prediction unit according to the search range from which a candidate size not supported in the AVC standard is excluded.

(12)

The image processing apparatus according to (10),

wherein the setting section sets a size of a transform unit serving as a unit in which an orthogonal transform process is performed according to the search range of the size of the transform unit, a candidate size not supported in the AVC standard being excluded from the search range.

(13)

The image processing apparatus according to any one of (1) to (12), further including:

a control unit configured to set the search range to a first range in a first operation mode, and set the search range to a second range narrower than the first range in a second operation mode different from the first operation mode.

(14)

The image processing apparatus according to (13),

wherein the control unit selects the first operation mode or the second operation mode according to performance related to at least one of an encoding process and a prediction process.

(15)

The image processing apparatus according to any one of (1) to (14), further including:

a processing circuit configured to perform one or more of a prediction process, an orthogonal transform process, and an encoding process; and

a memory configured to store image data processed by the processing circuit, the memory being connected to the processing circuit via a bus.

(16)

An image processing method, including:

setting a size of at least one of a coding unit formed by recursively dividing an image to be encoded and a prediction unit to be set in the coding unit according to a search range of the size of the at least one of the coding unit and the prediction unit, one or more smallest candidate sizes among all candidate sizes being excluded from the search range; and

encoding the image according to the set size of the coding unit or the prediction unit.

(17)

A program for causing a processor that controls an image processing apparatus to function as

a setting section configured to set a size of at least one of a coding unit formed by recursively dividing an image to be encoded and a prediction unit to be set in the coding unit according to a search range of the size of the at least one of the coding unit and the prediction unit, one or more smallest candidate sizes among all candidate sizes being excluded from the search range,

wherein the image processing apparatus encodes the image according to the size of the coding unit or the prediction unit set by the setting section.

(18)

A computer readable storage medium having a program stored therein, the program causing a processor that controls an image processing apparatus to function as

a setting section configured to set a size of at least one of a coding unit formed by recursively dividing an image to be encoded and a prediction unit to be set in the coding unit according to a search range of the size of the at least one of the coding unit and the prediction unit, one or more smallest candidate sizes among all candidate sizes being excluded from the search range,

wherein the image processing apparatus encodes the image according to the size of the coding unit or the prediction unit set by the setting section.

### REFERENCE SIGNS LIST

10 image processing apparatus (image encoding device)
12 block control section
14 orthogonal transform section
16 lossless encoding section
27 mode setting section
30 intra prediction section
40 inter prediction section

1. An image processing apparatus, comprising:
a setting section configured to set a size of at least one of a coding unit formed by recursively dividing an image to be encoded and a prediction unit to be set in the coding unit according to a search range of the size of the at least one of the coding unit and the prediction unit, one or more smallest candidate sizes among all candidate sizes being excluded from the search range; and
an encoding section configured to encode the image according to the size of the coding unit or the prediction unit set by the setting section.

2. The image processing apparatus according to claim 1,
wherein the setting section sets the size of the prediction unit according to the search range from which a candidate size different from the size of the coding unit is excluded.

3. The image processing apparatus according to claim 1,
wherein the setting section sets a size of a transform unit serving as a unit in which an orthogonal transform process is performed according to a search range of the size of the transform unit, a candidate size different from the size of the coding unit being excluded from the search range.

4. The image processing apparatus according to claim 1,
wherein the setting section sets the size of the coding unit according to the search range from which a candidate size of 8×8 pixels is excluded.

5. The image processing apparatus according to claim 1,
wherein the setting section sets the size of the prediction unit with which intra prediction is performed according to the search range from which a candidate size of 4×4 pixels is excluded.

6. The image processing apparatus according to claim 1,
wherein the setting section sets the size of the at least one of the coding unit and the prediction unit according to the search range from which one or more largest candidate sizes among all candidates sizes are excluded.

7. The image processing apparatus according to claim 6,
wherein the setting section sets the size of the coding unit according to the search range from which a candidate size of 64×64 pixels is excluded.

8. The image processing apparatus according to claim 1,
wherein the setting section sets a size of a transform unit serving as a unit in which an orthogonal transform process is performed according to a search range of the size of the transform unit, one or more largest candidate sizes among all candidate sizes being excluded from the search range.

9. The image processing apparatus according to claim 8,
wherein the setting section sets the size of the transform unit according to the search range from which a candidate size of 32×32 pixels is excluded.

10. The image processing apparatus according to claim 1,
wherein the setting section sets the size of the coding unit according to the search range from which a candidate size not supported in an Advanced Video Coding (AVC) standard is excluded.

11. The image processing apparatus according to claim 10,
wherein the setting section sets the size of the prediction unit according to the search range from which a candidate size not supported in the AVC standard is excluded.

12. The image processing apparatus according to claim 10,
wherein the setting section sets a size of a transform unit serving as a unit in which an orthogonal transform process is performed according to the search range of the size of the transform unit, a candidate size not supported in the AVC standard being excluded from the search range.

13. The image processing apparatus according to claim 1, further comprising:
a control unit configured to set the search range to a first range in a first operation mode, and set the search range to a second range narrower than the first range in a second operation mode different from the first operation mode.

14. The image processing apparatus according to claim 13,
wherein the control unit selects the first operation mode or the second operation mode according to performance related to at least one of an encoding process and a prediction process.

15. The image processing apparatus according to claim 1, further comprising:
a processing circuit configured to perform one or more of a prediction process, an orthogonal transform process, and an encoding process; and
a memory configured to store image data processed by the processing circuit, the memory being connected to the processing circuit via a bus.

16. An image processing method, comprising:
setting a size of at least one of a coding unit formed by recursively dividing an image to be encoded and a prediction unit to be set in the coding unit according to a search range of the size of the at least one of the coding unit and the prediction unit, one or more smallest candidate sizes among all candidate sizes being excluded from the search range; and
encoding the image according to the set size of the coding unit or the prediction unit.
